(19) United States
(12) Patent Application Publication
(10) Pub. No.: US 2026/0327005 A1
(43) Pub. Date: Oct. 22, 2026

(54) STORAGE SYSTEM AND STORAGE CONTAINER

(71) Applicant: Ocado Innovation Limited, Hatfield (GB)

(72) Inventors: Matthew William NORTH, Redhill (GB); Ian PARKS, Hatfield (GB); Paul BIRD, Hatfield (GB)

(21) Appl. No.: 19/529,186

(22) Filed: Feb. 4, 2026

Related U.S. Application Data
(63) Continuation of application No. PCT/EP2024/072743, filed on Aug. 12, 2024.

(30) Foreign Application Priority Data
Aug. 14, 2023 (GB) 2312390.4

(51) Int. Cl. B65G 1/04; B31B 50/74; B31B 120/00; B31B 120/40

(52) U.S. Cl. CPC B65G 1/0464; B31B 50/74; B31B 2120/407; B31B 2120/502; B65G 2201/025

(57) ABSTRACT

A storage and retrieval system includes a grid framework structure including storage columns for the storage of stacks of storage containers, a track system including tracks arranged in a grid pattern including grid cells arranged above the storage columns; stacks of storage containers, each stack occupying a single storage column, wherein each storage container comprises a bottom wall, upwardly standing sidewalls and an opening for receiving one or more items to define a box-like structure, each storage container further including a rim portion extending around at least a portion of the periphery of the opening of the box-like structure for supporting the bottom wall of an adjacent storage container above in a stack, wherein a portion of the box-like structure is formed from a cellulose material; and a plurality of robotic load handling devices moveable on the track system for lifting and moving storage containers stacked in the storage columns.

### RELATED APPLICATIONS

This application is a continuation application of International Patent Application No. PCT/EP 2024/072743 filed 12 Aug. 2024 and entitled “Storage System and Storage Container,” which claims priority to UK Patent Application No. GB 2312390.4 filed 14 Aug. 2023 and entitled “Storage System and Storage Container”; the entire contents of both of which applications are incorporated herein by reference.

### TECHNICAL FIELD

The present invention relates to the field of storage systems including load handling devices operative on tracks located on a grid framework structure for handling storage containers stacked in the grid framework structure, and storage containers for use in such storage systems.

### BACKGROUND

Some commercial and industrial activities require systems that enable the storage and retrieval of a large number of different products. One known type of system for the storage and retrieval of items in multiple product lines involves arranging storage containers (also known as bins or totes) in stacks on top of one another, the stacks being arranged in rows. The storage containers are removed from the stacks and accessed from above by load handling devices, removing the need for aisles between the rows and thereby allowing a large number of containers to be stored in a given space.

As shown in FIGS. 1 and 2, storage containers 10, also known as bins or totes, are stacked on top of one another to form stacks 12. The stacks 12 are arranged in a grid framework structure 14 in a warehousing or manufacturing environment. The grid framework is made up of a plurality of storage columns or grid columns 24. Each grid in the grid framework structure has at least one grid column for storage of a stack of containers 12. FIG. 1 is a schematic perspective view of the grid framework structure 14, and FIG. 2 is a top-down view showing a single stack 12 of containers 10 arranged within the grid framework structure 14. Each container or bin 10 typically holds a plurality of product items (not shown), and the product items within a container 10 may be identical, or may be of different product types depending on the application. Each container 10 may be used to store grocery items (i.e. food items), for example. Furthermore, the bins 10 may be physically subdivided to accommodate a plurality of different inventory items.

In the description below, bins 10 will be used to denote the storage containers intended for the storage of inventory items, while delivery containers DT will be used to denote containers filled or intended to be filled to fulfil customer orders placed by customers. It will be appreciated that this terminology is used for ease of reference and explanation within this document. However, it should be noted that the bins 10 and the containers DT may be of the same shape and configuration. Furthermore, delivery containers DT may be stored in bins 10 within the storage system or any part thereof.

The grid framework structure 14 comprises a plurality of upright members or upright columns 16 that support horizontal grid members 18, 20. A first set of parallel horizontal grid members 18 is arranged perpendicularly to a second set of parallel horizontal grid members 20 to form a track system 15 including a plurality of grid cells extending in a substantially horizontal plane and supported by the upright members 16. The members 16, 18, 20 are typically manufactured from metal and typically welded or bolted together or a combination of both. The containers 10 are stacked between the members 16, 18, 20 of the grid framework structure 14, so that the grid framework structure 14 guards against horizontal movement of the stacks 12 of containers 10, and guides vertical movement of the containers 10.

The top level of the grid framework structure 14 includes rails 22 arranged in a grid pattern across the top of the stacks 12. Referring additionally to FIG. 3, the rails 22 support a plurality of load handling devices 30. A first set 22a of parallel rails 22 guide movement of the robotic load handling devices 30 in a first direction (for example, an X-direction) across the top of the grid framework structure 14, and a second set 22b of parallel rails 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12.

Each load handling device 30 comprises a vehicle body 32 which is arranged to travel in the X and Y directions on the tracks or rails 22 of the grid frame structure 14, above the stacks 12 (see FIG. 4). FIGS. 4 and 5 shows a load handling device 30 according to an embodiment of the present invention and described in PCT Patent Publication No. WO2015/019055 (Ocado Innovation Limited) and International patent application WO2015/185628A describes a storage and fulfilment system in which stacks of storage containers are arranged within a grid framework structure. The containers are accessed by load handling devices operative on tracks located on the top of the grid framework structure.

The load handling device 30 comprises a vehicle body 32 equipped with a lifting mechanism 33 (see FIG. 4) including a winch or a crane mechanism 35 to lift a storage container or bin 10, also known as a tote, from above. The crane mechanism 35 comprises a winch cable 38 wound on a spool or reel and a grabber device 39. Typically, the lifting device comprises a set of lifting tethers 38 extending in a vertical direction and connected nearby or at the four corners of the grabber device 39 (one tether near each of the four corners of the grabber device) for releasable connection to a storage container 10. The grabber device 39 is configured to grip the top of the storage container 10 and lift it from a stack of containers in a storage system of the type shown in FIGS. 1 and 2. Typically, the grabber device 39 is configured as a lifting frame. Further details of the grabber device are discussed below.

The vehicle body 32 comprises an upper part and a lower part (see FIG. 5 (a and b)). The lower part is fitted with two sets of wheels 34, 36, which run on rails at the top of the framework structure of the storage system. The upper part of the vehicle body 32 may house a majority of the bulky components of the load handling device. Typically, the upper part of the vehicle body houses a driving mechanism for driving both the wheels and the lifting mechanism together with an on-board rechargeable power source for providing the power to the driving mechanism and the lifting mechanism.

The lower part of the vehicle body 32 comprises a wheel assembly that is are driven to enable movement of the vehicle in X and Y directions respectively along the rails. A first set of wheels 34, consisting of a pair of wheels 34 on the front of the vehicle 32 and a pair of wheels 34 on the back of the vehicle 32, are arranged to engage with two adjacent rails of the first set 22a of rails 22. Similarly, a second set of wheels 36, consisting of a pair of wheels 36 on each side of the vehicle 32, are arranged to engage with two adjacent rails of the second set 22b of rails 22. One or both sets of wheels can be moved vertically to lift each set of wheels clear of the respective rails, thereby allowing the vehicle to move in the desired direction. When the first set of wheels 34 is engaged with the first set of tracks or rails 22a and the second set of wheels 36 are lifted clear from the tracks or rails 22, the wheels 34 can be driven, by way of a drive mechanism (not shown) housed in the vehicle 32, to move the load handling device 30 in the X direction. To move the load handling device 30 in the Y direction, the first set of wheels 34 are lifted clear of the tracks or rails 22, and the second set of wheels 36 are lowered into engagement with the second set of tracks or rails 22a. The drive mechanism can then be used to drive the second set of wheels 36 to achieve movement in the Y direction. One or both sets of wheels can be moved vertically to lift each set of wheels clear of the respective rails, thereby allowing the vehicle to move in the desired direction on the track system.

The wheels are arranged around the periphery of a cavity or recess, known as a container-receiving recess 40, in the lower part. The recess 40 is sized to accommodate the storage container or bin 10 when it is lifted by the crane mechanism, as shown in FIG. 5 (a and b). When in the recess, the container is lifted clear of the rails beneath, so that the load handling device can move laterally to a different location. On reaching the target location, for example another stack, an access point in the storage system or a conveyor belt, the bin or storage container can be lowered from the container receiving space and released from the grabber device 39. In this way, one or more robotic load handling devices 30 can move around the top surface of the stacks 12 on the frame structure 14, as shown in FIG. 3 under the control of a centralised control utility (not shown). Each robotic load handling device 30 is provided with a lifting mechanism 38 for lifting one or more bins 10 from the stack 12 to access the required items stored therein.

The body of the vehicle 32 can comprise the container receiving space 40 in the form of a cavity for accommodating a bin 10 (see FIG. 5). The cavity 40 being of a size capable of holding a bin or storage container 10. The lifting mechanism including a set of lifting tethers 38 extending in a vertical direction are connected at the four corners of a lifting frame (not shown), otherwise known as the grabber device (one tether near each of the four corners of the grabber device) for releasable connection to a storage container. The grabber device is configured to releasably grip the top of a storage container to lift it from a stack of containers in a storage system of the type shown in FIGS. 1 and 3. The lifting mechanism lifts a bin 10 from the stack 12 to within the cavity 40 within the body of the vehicle 32. While the container receiving space 40 for accommodating a bin 10 when it is lifted by the winch means is arranged within the vehicle body 32 shown in FIG. 4, the present invention is not limited to the container receiving space 40 being located within the vehicle body 32. The present invention is also applicable to the container receiving space being located below a cantilever such as in the case where the vehicle body of the load handling device has a cantilever construction as described in WO2019/238702 (Autostore Technology AS). For the purpose of the invention, the term ‘vehicle body” is construed to optionally cover a cantilever such that the grabber device is located below the cantilever. However, for ease of explanation of the present invention, the container receiving space for receiving a container is arranged within a cavity or recess within the vehicle body. The container receiving space allows multiple products to be accessed from multiple locations in the grid and stacks at any one time.

The robotic load handling devices 30 remove bins 10 containing inventory items (not shown) therein and transport the bins 10 to pick stations (not shown) where the required inventory items 28 are removed from the bins 10 and placed into bins 10 including delivery containers DT. It is important to note that a delivery container DT may fit within a bin 10. The bins 10 may comprise inventory items or may comprise delivery containers DT. Furthermore, the delivery containers DT may comprise at least one bag, the inventory items being picked directly in to a bag at a pick station (not shown).

The empty bins 10 or the bins including delivery containers DT or the bins including delivery containers DT and bags may all be stored within the stacks 12. It will be appreciated that all the bins 10 have substantially the same external shape and configuration.

FIG. 3 shows a typical storage and retrieval system 1 as described above, the system having a plurality of load handling devices 30 active on the grid above the stacks 12. FIGS. 1 and 3 show the bins 10 in stacks 12 within the storage system. It will be appreciated that there may be a large number of storage containers or bins 10 in any given storage system and that many different items may be stored in the bins 10 in the stacks 12, each bin 10 may contain different categories of inventory items within a single stack 12.

In one storage and retrieval system described above and further in UK Patent Application Publication Number GB 2517264 (Ocado Innovation Limited) and related U.S. Pat. No. 9,796,080, which is incorporated herein by reference in its entirety, the storage and retrieval system comprises a series of bins 10 that may further comprise delivery containers DT with customer orders contained therein or may further comprise bins 10 with inventory items awaiting picking contained therein. These different bins 10 and combinations thereof may be contained in the storage system and be accessed by the robotic load handling devices 30 as described above.,

The storage containers in such storage systems are typically made of a thermoplastic material and may be formed by injection moulding or blow moulding, for example. Examples of thermoplastic materials include polypropylene, polyethylene (e.g., high-density polyethylene (HDPE)), acrylonitrile butadiene styrene (ABS) and polycarbonate.

A problem with using thermoplastic storage containers in the storage systems described above is that they can be highly flammable and emit toxic fumes, and given that the storage system may contain hundreds or thousands of storage containers, the storage containers pose a significant risk in the event of a fire. To overcome the issue of the flammability of the storage containers, there has been a move towards the use of metal in the fabrication of the storage container. In comparison to thermoplastic material, the use of metal in the fabrication of the storage containers allows the storage containers to withstand much higher temperatures before disintegrating and emit very little or no toxic fumes in an event of a fire.

WO2022161863 (Autostore Tech AS) teaches a storage container for an automated storage and retrieval system and being configured to be stacked in a stack of storage containers such that an underlying storage container supports the storage container(s) positioned above. The storage container is adapted to be lifted by grippers on a lifting device such that the storage container can be lifted from above. The storage container comprises: a base and four sides hingedly connected to an edge of the base. The base and four sides are made from a sheet metal blank. The four sides are hingedly connected to the base by a live hinge. Four corner posts, each configured to interconnect a pair of adjacent sides to each other in a horizontal direction when the sides are positioned substantially 90 degrees relative the base and relative each other. The corner ports function as structural posts taking up the vertical loads supporting storage containers positioned above in a stack. To maintain the lightness of the storage container, the four corner posts are made from a non-metallic material, e.g. plastic material.

WO2022229453 (Ocado Innovation Limited) teaches a storage container for storage of one or more items in a storage and retrieval system comprising a track system comprising a first and second set of horizontal parallel tracks forming a grid pattern comprising a plurality of grid spaces and stacks of storage containers located beneath the track system and wherein each stack occupies a single grid space. The storage container comprises a metallic container body comprising a base portion formed as a single unitary body and having a container bottom wall and upwardly standing base sidewall and end wall parts to define a tray, and a separate upper portion having upper sidewall and end wall parts upwardly extending from and connected to the respective base sidewall and end wall parts to form a box-like structure with an open end for receiving the one or more items within the box-like structure.

However, one of the main criteria in the fabrication of storage containers for use in a storage and retrieval system discussed above is the cost of the storage containers. Considering that a typical storage and retrieval system can hold up to thousands of storage containers, the cost of the storage containers represents a significant cost of the storage and retrieval system.

A storage and retrieval system comprising low-cost storage containers having sufficient structural rigidity to withstand loads being applied to them when placed in a stack is thus required. Further, it would be beneficial to have storage containers that provide the possibility of quelling a fire in the storage and retrieval system quickly and easily.

It will be appreciated that while the system, apparatus and devices described herein are described for using grocery systems as an example, automated or semi-automated storage and retrieval systems are not limited to systems directed to groceries. For example, the technology can be applied to non-grocery storage, self-storage facilities, manufacturing facilities and general logistics to name a few possible applications. It will be appreciated that storage and retrieval systems of different types will have different technical requirements.

### SUMMARY OF INVENTION

Aspects of the invention are set out in the accompanying claims.

An aspect of the present invention described by the present disclosure is directed to and provides storage and retrieval systems. An example storage and retrieval system comprises:
(a) a grid framework structure comprising a plurality of storage columns for the storage of a plurality of stacks of storage containers, a track system comprising a plurality of tracks arranged in a grid pattern comprising a plurality of grid cells arranged above the plurality of storage columns for guiding one or more robotic load handling devices on the grid framework structure, the plurality of tracks being arranged such that each of the plurality of storage columns is below a single grid cell;
(b) a plurality of stacks of storage containers, each stack of the plurality of storage containers occupying a single storage column of the plurality of storage columns, wherein each storage container of the plurality of stacks of storage containers comprises a bottom wall, upwardly standing sidewalls and an opening for receiving one or more items to define a box-like structure, each storage container further comprising a rim portion extending around at least a portion of the periphery of the opening of the box-like structure for supporting the bottom wall of an adjacent storage container above in a stack, and wherein a portion of the box-like structure of the at least one storage container in the one or more of the plurality of stacks of storage containers is formed from a cellulose material;
(c) a plurality of robotic load handling devices for lifting and moving storage containers stacked in the storage columns, the plurality of load handling devices being remotely operated to move laterally on the track system above the plurality of storage columns to access the storage containers through the grid cells, each of said plurality of robotic load handling devices comprising:
(i) a wheel assembly for guiding the load handling device on the track system; (ii) a container-receiving space located above the track system; and (iii) a lifting device arranged to lift a single storage container from a stack into the container-receiving space, wherein the lifting device comprises a grabber device being configured to engage with the storage container, wherein the grabber device comprises gripper elements for engaging with the rim portion of the storage container.

Cellulosic storage containers are less costly than prior art containers, e.g. metal and plastic containers. Storage containers formed from a cellulose material and stacked in a plurality of stacks therefore represents a significant cost saving when there are hundreds of storage containers present within the grid framework structure. In this application, the term ‘storage container’ is used interchangeably with the term ‘container’.

Further, the storage containers are able to be stacked on top of each other because the rim portion that extends around at least a portion of the periphery of the opening of the box-like structure supports the bottom wall of an adjacent storage container above in a stack. Specifically, the rim portion provides a supporting surface for the container bottom wall of the adjacent storage container immediately above the storage container. The container bottom wall of a vertically adjacent storage container above in a stack can therefore rest on the rim portion without the problem of the contents of the storage container below being crushed, damaged or fouled by the bottom container wall of the vertically adjacent storage container. If the storage containers comprise solid upwardly standing sidewalls (i.e. there are no holes in the upwardly standing sidewalls), this further increases the structural rigidity of the storage containers, thereby enabling them to withstand loads being applied to them when placed in a stack, for example the storage containers may each be able to hold a load of inventory items of around 30 kg, and be stacked in stacks of up to 21 high, therefore a storage container at the bottom of the stack supports a load of around 630 kg.

The rim portion presents another advantage by allowing gripper elements of a grabber device of a robotic load handling device to engage with the rim portion. This means that the grabber device can have a firm grip of a storage container when lifting the storage container, thereby reducing the possibility of gripped storage container slipping or falling as it is being lifted by the load handling device.

If a fire were to initiate in the present system, the fire could easily be extinguished by water from a sprinkler system or hose because the storage containers comprise cellulose. Cellulose materials may include cardboard, wood, paper, cotton, hemp and linen. In contrast, if the system comprised metal storage containers, any fire would need to be extinguished by a powder fire extinguisher that would cover the fire in a non-reactive powder and the fire could not be put out by using just water. Thus the present invention allows a fire to be put out without necessarily requiring the presence of the fire brigade and instead uses a conventional fire sprinkler system positioned above the storage and retrieval system. Since the storage and retrieval system of the present invention may comprise stacks of up to 21 storage containers, the system may be required to be housed in a tall building or warehouse. Installation of sprinkler systems in tall buildings is recommended so any such building would likely already have a conventional fire sprinkler system installed on the ceiling, thus assembling the storage and retrieval system of the present invention in such a building would not necessarily require the installation of any further fire extinguishing apparatus.

Extreme heat or a flame within the grid framework structure may cause the storage containers to catch fire. If the cellulosic storage containers catch fire, instead of the containers burning slowly with smoke and no flame (i.e. smouldering), the fire spreads quickly due to the high flammability of the cellulose fibres and moves up the stack of containers. In order for the fire to move up the stack of containers, rather than across containers in other stacks, each container may comprise solid upwardly standing side-walls (i.e., there are no holes in the upwardly standing sidewalls), which reduces lateral air flow from a stack to an adjacent stack. Once the fire reaches the top of the stack of containers, a fire sprinkler system positioned above the grid framework structure is triggered by the heat to activate and put out the fire. Water from the sprinkler system is absorbed by the cellulose in the storage containers at the top of the stacks. Specifically, water from the sprinkler system is absorbed into cellulosic fibres that comprise hydrophilic-OH groups. Once the cellulosic fibres of the containers at the top of the stacks become saturated with water, the containers will start to drip water into the containers lower down the stack. Further, water from the sprinkler system also reaches the exterior of the containers in the stacks and is absorbed by the upwardly standing sidewalls of the storage containers. Thus, water can move quickly through the stacks of containers, thereby putting out a fire in a short space of time.

Embodiments and exampled of the present invention therefore are directed to and present systems where a fire can be put out quickly and effectively before the fire becomes widespread by utilising the stacking arrangement of the cellulosic storage containers to guide the flame up the stack towards the sprinkler system. In addition, a cellulosic storage container emits less toxic fumes than plastic containers therefore, in this respect, burning cellulosic storage containers is less environmentally harmful to the environment than burning plastic containers. Further, there is less damaged stock from fumes when using cellulosic storage containers compared to plastic storage containers. Further still, it is quicker and easier to clean up the remnants of burnt cellulosic storage containers and get the storage and retrieval system back into an operable state compared to clearing up after a fire in a storage system comprising plastic storage containers.

The upwardly standing sidewalls of the storage containers may include walls at the front and/or back and/or right side and/or left side of the storage container. Optionally, a portion of the box-like structure of the at least one storage container in the one or more of the plurality of stacks of storage containers comprises the one or more upwardly standing sidewalls and/or bottom wall. Thus, the upwardly standing sidewalls and/or the bottom wall of each storage container may be formed from a cellulose material. For example, the bottom wall of each storage container may be formed from plastic or metal while the upwardly standing sidewalls may be formed from a cellulose material. In this arrangement, the plastic or metal bottom wall may provide a leak proof base for catching any juices or liquids that escape from the products stored in the storage containers, and water from the sprinkler system can travel down the cellulosic upwardly standing side walls of a stack of containers thus still enabling a fire to be extinguished quickly as described above.

The cellulose material may be cardboard. Cardboard is particularly advantageous because it is readily available, cost effective and can be folded into a desired shape. In particular, cardboard is light and thus the weight of storage containers in the storage and retrieval system is significantly reduced leading to faster storage and retrieval system installation because there is no requirement to install a reinforced base for the system to rest on. This means that the present storage and retrieval system can be installed in existing buildings, thereby reducing installation costs.

At least a portion of the cellulose material may be coated in polypropylene, or impregnated or coated with a wax material, such that it retains grease and moisture within the storage container.

Optionally the box-like structure of the at least one storage container is formed from a folded cardboard blank. Thus, large numbers of pre-assembled storage containers can easily be transported and be assembled without the requirement of tools, and without the requirement for fixings, such as glue or tape. Optionally, the folded cardboard blank comprises a base portion and outwardly extending panel portions, the outwardly extending panel portions being folded along respective fold lines relative to the base portion forming the upwardly standing sidewalls. To provide sufficient structural rigidity to the walls of the storage container, preferably the cardboard blank is double corrugated (i.e. comprising three sheets and two layers of corrugated cardboard). The thickness of the layers of corrugated cardboard may be between 5 and 7 mm, in some examples.

The rim portion may comprise one or more engagement features for engaging with the gripper elements of the grabber device. The engagement features improve the grip that the gripper elements have on the storage container. The engagement features may include one or more hooks onto which the gripper element can latch. Alternatively, the engagement features of the rim portion may comprise a plurality of apertures for receiving the gripper elements of the grabber device. The apertures may be sized such that the gripper elements are receivable in the apertures and such that the gripper elements are engageable with the rim portion.

Each storage container may further comprise a cap engaged at each of the corners of the box-like structure, each cap comprising a first portion and a second portion, the first portion extending in a first direction and the second portion extending in a second direction, the first portion being substantially perpendicular to the second portion to define a corner piece, the corner piece being configured to be mounted at a corner of the storage container such that the first and second portions hold adjacent upwardly standing sidewalls together at each corner of the box-like structure. The corner piece advantageously provides structural rigidity at the corner of the storage container, and ensures that each storage container has the same box-like shape (i.e. same x and y dimensions) such that each storage container can be stacked one on-top of the other.

Optionally, the first portion and/or the second portion comprise one or more cap apertures that are configured to align with the one or more apertures in the rim portion when the corner piece is mounted to the corner of the storage container such that each of the one or more cap apertures reinforces the periphery of each of the apertures in the rim portion. This arrangement means that the lifetime of the apertures in the rim portion is extended and the apertures in the rim portion are not degraded from the storage container being gripped and lifted multiple times.

The cap may further comprise a third portion downwardly extending in a third direction, the third direction being perpendicular to the first direction and the second direction to define a grabber device guide, each guide being configured to extend along each corner of the storage container to align the gripper element of the grabber device with the aperture of the rim portion so as to allow the grabber device to engage with the rim portion of the storage container. The grabber device guide at each of the corners of the storage container may extend vertically at least partially along the height of the storage container for accommodating guiding pins or locating pins of the grabber device. This means that the gripper elements of the grabber device can properly align with the apertures in the rim portion of the storage container.

Each cap may comprise plastic. For example, each cap may comprise polystyrene, nylon, polyethylene or polyurethane. Since plastic is more rigid and stronger than cardboard, the cap ensures that the cardboard sidewalls do not flex and bend out of position at the corners which would disrupt the stacking arrangement of the storage containers. If cap apertures are present, the cap comprising plastic also ensures that the apertures in the rim portion are more rigidly reinforced. Further, the plastic caps may be re-used, such that when a storage container reaches the end of its working life, the caps at each corner of the storage container may be removed, the portion of the box-like structure of the storage container formed from a cellulose material can be recycled and the caps may be placed at the corner of a new storage container.

Each storage container may further comprise a tubular reinforcement post at each corner of the storage container. The tubular reinforcement post may be a separate component of the storage container, for example, the tubular reinforcement post may be a plastic or metal post. In this case, the tubular reinforcement posts may be re-used when the storage container has reached the end of its working life. Each plastic or metal post may be attached to each corner using glue or another such fixing method. An advantage of having a plastic or metal post as a tubular reinforcement post is the metal and plastic are more durable and stronger than cardboard. Alternatively, the tubular reinforcement post may be integral to the box-like structure of the storage container and therefore formed of a cellulosic material, for example cardboard. The tubular reinforcement post may be formed from the folded cardboard blank. The tubular reinforcement post of either the integral or separate arrangements may have a cross section in the shape of a triangle or a square or a rectangle. Having a tubular reinforcement post at each corner of the box-like structure of the storage container means that there is increased strength and rigidity at each corner resulting in increased stability in the stacks of storage containers.

The storage and retrieval system reduces waste generation by either recycling (for example the portion of the box-like structure of the storage container formed from a cellulose material) or re-using (for example, the caps and tubular reinforcement posts) all parts of the storage containers. It takes less energy to recycle cardboard, for example, than it does to make it from raw materials, thus reducing carbon and other greenhouse emissions. Reusing products means that less energy is consumed to manufacture and transport products and their packaging and as a result, less carbon dioxide and other greenhouse gas emissions are generated. Thus, the storage containers in the system reduces the impact on the environment compared to containers in prior art systems.

The storage container may comprise a liner being formed from a second blank. The second blank may be a food-grade material, for example the second blank may be a cardboard blank or a plastic blank. This means that the second blank is non-toxic and can come into direct contact with food meant for human consumption. Further, using a plastic blank is particularly advantageous because it allows the blank to be washed and re-used. Possible plastics that are food-grade materials include high-density polyethylene (HDPE plastic), low-density polyethylene (LDPE plastic), polyethylene terephthalate (PET), food-grade polypropylene (PP), polycarbonate, acrylic, nylon and bioplastics. Thus, having a second blank made of a food-grade material results in a liner that is food safe, provided it meets the conditions which are required for its use, for example, storing solid food products for several hours or days. An advantage of using cardboard as a material for the second blank is that it is strong, lightweight and cheap. Since it is made from natural resources, cardboard can be disposed easily and is inherently recyclable, compostable and biodegradable. An advantage of using a food-grade plastic for the second blank is that the blank has increased durability and strength, and is substantially leak-proof. Bioplastics, formed from materials derived from biological substances rather than petroleum, offer a greener alternative than other plastics. From manufacture to disposal, bioplastics produce significantly fewer greenhouse gases than conventional plastics, and will biodegrade naturally over time. Additionally, the plant-based oils found in most bioplastics provides improved flexibility that is suitable for use as a blank for a liner.

While the liner may be formed from a second blank, it is also possible for the liner may also be a shallow tray to provide a covering for at least a portion of the interior surface of the box-like structure of the storage container. This provides a leak-proof base in the event that any juices or liquids escape from food items in the storage container, and prevents the storage container contaminating food items in a storage container below in a stack. In this case, the shallow tray may comprise food-grade plastics.

The second blank may comprise a base portion and a pair of outwardly extending panel portions, the outwardly extending panel portions being folded along respective fold lines relative to the base portion forming a substantially U-shaped structure comprising upwardly standing liner sidewalls. The upwardly standing liner sidewalls of the liner may form interior surfaces of the shorter upwardly standing sidewalls of the storage container or the longer upwardly standing sidewalls of the storage container.

The second blank may comprise a flange formed at each edge of the upwardly standing liner sidewalls, the flange being foldable inwardly upon itself along two parallel fold lines to form the tubular reinforcement post. Thus, the tubular reinforcement post is integral with the storage container. The tubular reinforcement post may have a triangular, square or rectangular cross-section.

The tubular reinforcement post, either as a separate piece or integral with the storage container may be held in the corner of the storage container by the corner piece. Specifically, the corner piece may comprise a ridge on its underside for retaining the tubular reinforcement post in position. Alternatively, or in addition, the tubular reinforcement post may be fixed into position using glue, or another such fixing means.

The second blank may comprise a base wall and two pairs of outwardly extending panel portions, the outwardly extending panel portions being folded along respective fold lines relative to the base portion forming a box-like liner structure. Each of the outwardly extending panel portions in one of the pairs of outwardly extending panel portions may comprise a pair of wings. The pair of wings may be folded such that each wing overlaps or underlaps each corner of box-like liner structure. The pair of wings may be fastened, once folded, by any conventional means, for example, gluing, welding, soldering, riveting or using nuts and bolts. The pair of wings may be fastened to each other, or each may be fastened to an upwardly standing liner sidewall to retain each wing in its folded position. By folding a wing over each corner of the liner, each corner of the liner is reinforced. The second blank may comprise metal, plastic or cardboard coated in polypropylene. By using any of these materials and folding each wing over each corner of the box-like liner structure, fluid within the liner can be retained, thereby providing a leak-proof interior.

The storage and retrieval system may comprise a plurality of dividers for dividing up the storage volume into sections. A fire may be contained within a small section thereby preventing spreading of the fire. The dividers may be formed from steel, aluminium or any other material suitable for dividing the storage system. Each divider may comprise a solid, fixed installation extending from the base of the grid framework structure up to the track system. The dividers may be formed from steel, aluminium or any other material suitable for dividing the storage and retrieval system. Sprinkler means may be positioned such that, in the event of a fire, water from the sprinkler system will only fall in the section of the storage and retrieval system affected. Advantageously, the dividers prevent water from spreading to portions of the storage system not affected by the fire. In this way, any discharged water stays in one compartment of the storage and retrieval system, where it helps in cooling and/or extinguishing the fire. Any water damage would not spread to other compartments, thereby limiting the total scope of the damage. The space around the solid dividers may also be used to allow for installing pipes for a slow and controlled drainage of the water after sprinkler release.

The dividers may be releasably deployable from the underside of the track system. The dividers may comprise openable and closeable shutter systems to enable a more flexible partitioning system. The dividers may be mounted on the underside of the track system and be deployed only in the event of a fire being detected. Alternatively, the releasably deployable dividers may be deployed in response to a requirement to cool part of the storage and retrieval system. The releasably deployable dividers may take the form of roller shutters deployable in response to a predetermined signal indicating a requirement to partition a part of the system.

The storage and retrieval system may comprise drainage means in sub-sections of the storage and retrieval system in order to facilitate drainage of any fluids deployed via a sprinkler activation. The drainage means may be incorporated in systems having permanent dividers, deployable dividers or both.

To completely section off a stack or number of stacks to a load handling device operable on the track system, the storage and retrieval system may comprise deployable shutter means located under the track system which are deployable horizontally across a stack or number of stacks. Alternatively, the space above each divider may be equipped with guard rails which may be individually raised. In use, the guard rails would be raised to prevent the load handling devices from travelling from one section of the storage and retrieval system to another.

The uprights of the grid framework structure may carry a water supply throughout the grid framework structure. The water supply may be directed from the uprights to the individual bins, for example water may be sprayed on to the bins from the uprights. Additionally, or alternatively, the uprights may comprise sensing means to detect fire, smoke, heat or gas within the frame structure.

The storage and retrieval system may further comprise one or more service load handling devices comprising fire extinguishing means. The fire extinguishing means may comprise one or more spray devices capable of discharging a fire extinguishing material. Fire extinguishing materials may include but not be limited to fire extinguishing foam, fire extinguishing powder and water or other fire extinguishing liquid. Suitable fire extinguishing materials may be selected from, by way of example only, powder, foam, fluid, aerosol, gas, pellets, gel, liquid and water. Optionally, the one or more spray devices may be moveable so that the spray device can be directed onto a fire so the fire extinguishing material is discharged directly onto a fire. The one or more service load handling devices may be provided with suitable pumping means to pump the fire extinguishing material from a tank or supply located within the device, out of a nozzle towards the fire. The directionality of the deployment of the material may be governed by the geometry of the nozzle or spray device. Alternatively the deployment of the material may be computer controlled or remotely but manually controlled by a user located at a control point on the system.

The storage and retrieval system may further comprise fire detectors located through the storage and retrieval system. The fire detectors may continuously monitor for signs of a fire. The fire detectors may be selected, by way of example, from smoke detectors, heat sensors, optical sensors and audio sensors. Optionally, heat sensors or other detecting means may be carried on the service load handling devices and may be used to identify the position of a fire and direct the spray device towards the fire.

Other variations and advantages will become apparent from the following description.

### BRIEF DESCRIPTION OF THE DRAWINGS

Further features and aspects of the present invention will be apparent from the following detailed description of an illustrative embodiment made with reference to the drawings, in which:

FIG. 1 is an illustration of an automated storage and retrieval system according to an exemplary embodiment of the present invention.

FIG. 2 is a schematic diagram of a top-down view showing a stack of bins arranged within the framework structure of FIG. 1.

FIG. 3 is a schematic diagram of a system of a known load handling device operating on the grid framework structure.

FIG. 4 is a schematic perspective view of the load handling device showing the container receiving space within the body of the load handling device.

FIG. 5 includes views (a) and (b), which are schematic perspective cut away views of the load handling device of FIG. 4 showing, inn view (a), a container accommodating a container receiving space of the load handling device the container receiving space of the load handling device and, in view (b), the container receiving space of the load handling device a container accommodating the container receiving space of the load handling device.

FIG. 6 is a schematic perspective view of the grabber device positioned above the storage container.

FIG. 7, includes views (a) and (b), and illustrates the different configurations of a grabber device of a load handling device interacting with a storage container; view (a) is a schematic perspective view of the grabber device in a collapsed configuration mounted on the storage container, while view (b) is a schematic perspective view of the grabber device in an open enlarged configuration mounted on the storage container.

FIG. 8 is a schematic perspective view of a storage container.

FIG. 9 is an exploded perspective view of the storage container of FIG. 8 that comprises a liner.

FIG. 10 is a top view of a blank for the storage container of FIGS. 8 and 9.

FIG. 11 is a top view of a blank for the liner of the storage container of FIGS. 8 and 9.

FIG. 12 is a schematic perspective view of the storage container of FIGS. 8 and 9 additionally comprising a cap at each corner of the storage container.

FIG. 13 is an exploded perspective view of the storage container of FIG. 12.

FIG. 14 is schematic perspective view of the grabber device positioned in line with the caps of the storage container of FIG. 12.

FIG. 15 is a schematic perspective view of the grabber device interacting with the storage container of FIG. 12.

FIG. 16 includes views (a) and (b), where (a) is a schematic perspective view of an alternative liner, and view (b) is a top view of a blank for forming the liner of view (a).

FIG. 17 is a schematic perspective view of the storage and retrieval system of the present invention.

In the figures, like features are denoted by like reference signs where appropriate.

### DETAILED DESCRIPTION

The following embodiments represent preferred examples of how the invention may be practised, but they are not necessarily the only examples of how this could be achieve. These examples are described in sufficient detail to enable those skilled in the art to practise the invention. Other examples may be utilised and structural changes may be made without departing from the scope of the invention as defined in the appended claims. Moreover, direction references and any other terms having an implied orientation are given by way of example to aid the reader's understanding of the particular examples described herein. They should not be read to be requirements or limitations, particularly as to the position, orientation, or use of the invention unless specifically set forth in the appended claims. Similarly, connection references (e.g., attached, coupled, connected, joined, secured, and the like) are to be construed broadly and may include intermediate members between a connection of elements and relative movement between elements. As such, connection references do not necessarily infer that two elements are directly connected and in fixed relation to each other, unless specifically set forth in the appended claims. Similarly, wording such as “in the n-direction” and any comparable wording, where n is one of x, y, or z, is intended to mean substantially along or parallel to the n-axis in either direction (i.e. towards the positive end of the n-axis or towards the negative end of the n-axis).

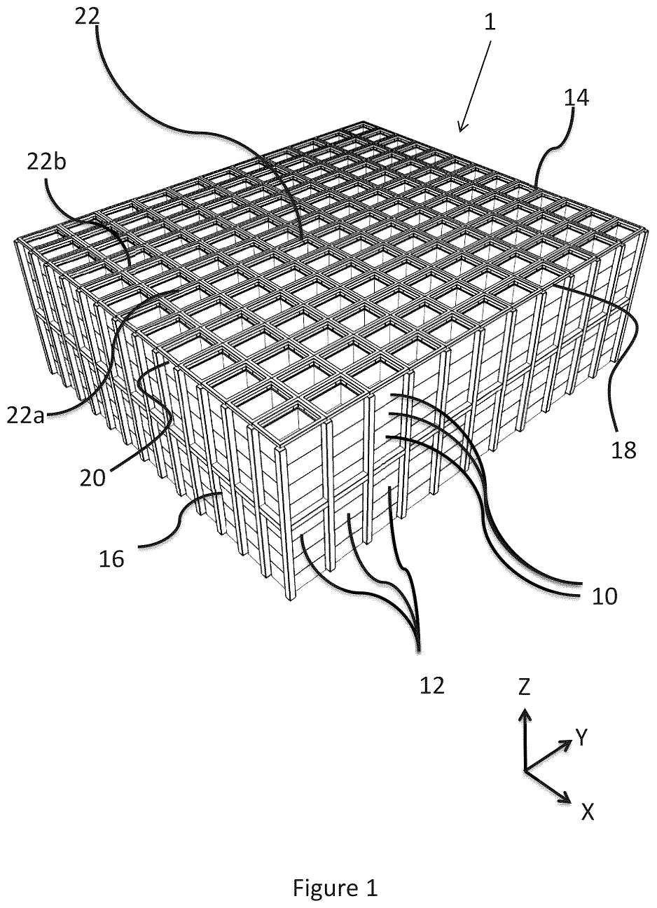

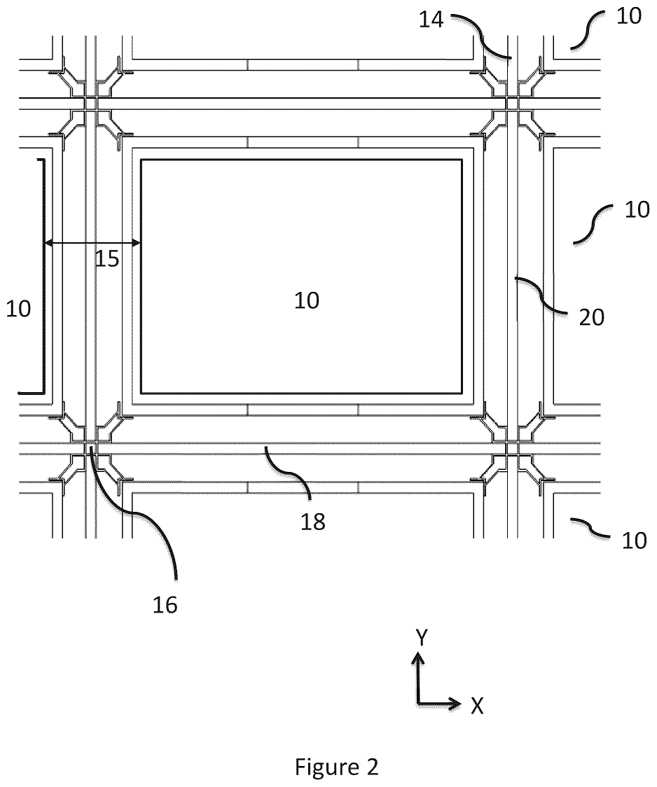

FIGS. 1 to 3 of the accompanying drawings illustrate a storage and retrieval system. As shown in FIGS. 1 and 2, stackable containers, known as storage bins or containers 10, are stacked on top of one another to form stacks 12. The stacks 12 are arranged in a three-dimensional (3D) grid framework structure 14 in a warehousing or manufacturing environment. The grid framework structure is made up of a plurality of storage columns or grid columns. FIG. 1 is a schematic perspective view of the grid framework structure 14, and FIG. 2 is a top-down view showing a stack 12 of bins 10 arranged within the framework structure 14. Each bin 10 typically holds a plurality of product items (not shown), and the product items within a bin 10 may be identical, or may be of different product types depending on the application. Bins 10 may also be referred to as storage bins or containers or storage containers or totes.

The grid framework structure comprises a supporting framework structure, upon which is mounted a track system for supporting the load handling devices. In the particular example of a grid framework structure illustrated in FIGS. 1 to 3, the supporting framework structure 14 comprises a plurality of vertical uprights or upright members or upright columns 16 that support horizontal grid members 18, 20. A first set of parallel horizontal grid members 18 is arranged perpendicularly to a second set of parallel horizontal grid members 20 to form a grid structure or grid 15 comprising a plurality of grid cells 17. The grid cell has an opening to allow a load handling device to lift a container or storage bin through the grid cell. In the grid structure, the first set of parallel horizontal grid members 18 intersect the second set of parallel horizontal grid members at nodes. The grid structure 15 is supported by the upright members 16 at each of the nodes or at the point where the grid members intersect such that the upright members are interconnected at their tops ends by the intersecting grid members. The grid members 16, 18, 20 are typically manufactured from metal and typically welded or bolted together or a combination of both. The storage bins or containers 10 are stacked between the upright members 16 of the grid framework structure 14, so that the upright members 16 guard against horizontal movement of the stacks 12 of bins 10, and guide vertical movement of the storage bins 10.

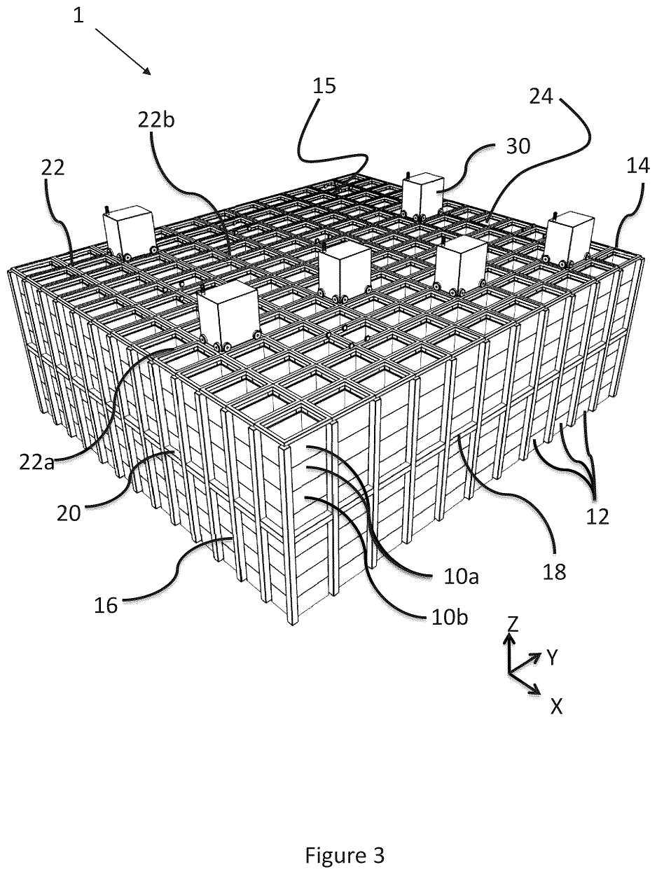

The top level of the grid framework structure 14 includes rails 22 arranged in a grid pattern across the top of the stacks 12. Referring additionally to FIG. 3, the rails 22 support a plurality of load handling devices 30. A first set 22a of parallel rails 22 guide movement of the robotic load handling devices 30 in a first direction (for example, an X-direction) across the top of the grid framework structure 14, and a second set 22b of parallel rails 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12.

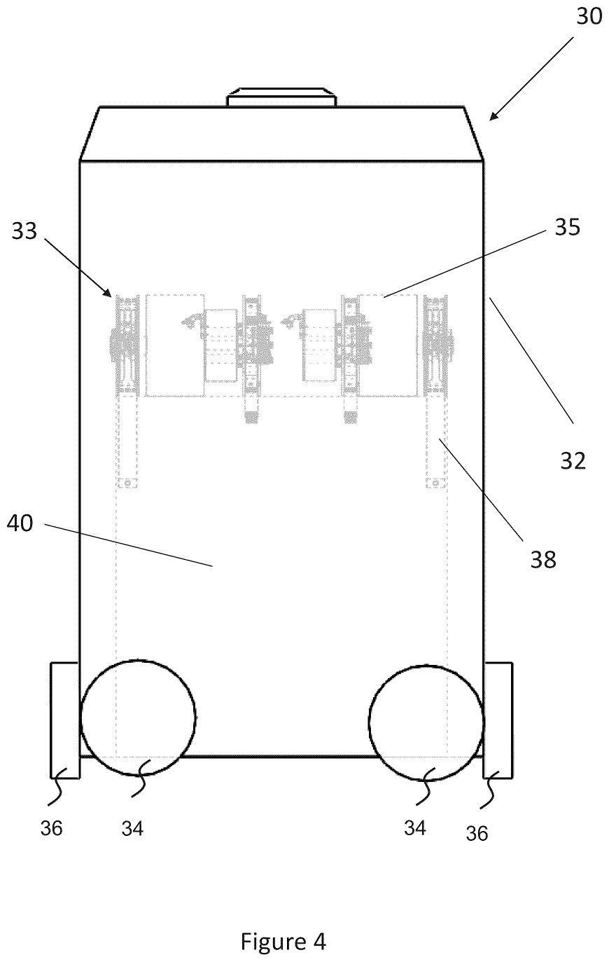

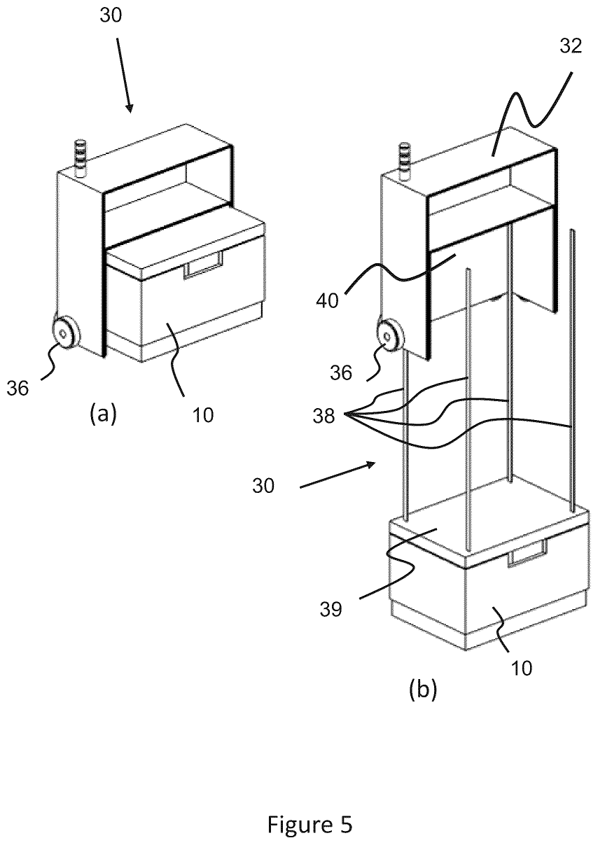

A load handling device or robotic load handling device otherwise known as a bot 30 shown in FIGS. 4 and 5 comprising a vehicle body 32 is described in PCT Patent Publication No. WO 2015/019055 (Ocado Innovation Limited) and related U.S. Pat. No. 10,000,337, which is incorporated herein by reference in its entirety, where each load handling device 30 only covers a single grid space or grid cell of the grid framework structure 14. Here, the load handling device 30 comprises a wheel assembly comprising a first set of wheels 34 consisting of a pair of wheels on the front of the vehicle body 32 and a pair of wheels 34 on the back of the vehicle 32 for engaging with the first set of rails or tracks to guide movement of the device in a first direction, and a second set of wheels 36 consisting of a pair of wheels 36 on each side of the vehicle 32 for engaging with the second set of rails or tracks to guide movement of the device in a second direction. Each of the sets of wheels are driven to enable movement of the vehicle in X and Y directions respectively along the rails. One or both sets of wheels can be moved vertically to lift each set of wheels clear of the respective rails, thereby allowing the vehicle to move in the desired direction, e.g., X or Y direction on the grid structure.

International Patent Application Publication No. WO2017/153583 (Ocado Innovation Limited)—and its related U.S. Pat. No. 11,273,980, the entire content of which is incorporated herein by reference-teaches a load handling device comprising a wheel positioning mechanism or directional change mechanism for enabling lateral movement of the device in one of two transverse directions by enabling either a first or second set of wheels to selectively engage the first or second set of rails or tracks (22a or 22b). The wheel positioning mechanism comprises a complicated arrangement of linkages driven by a linear actuator or motor to selectively lower or raise the first set of wheels or the second set of wheels into engagement or disengagement with the first set of tracks or rails or the second set of tracks or rails.

The load handling device 30 is equipped with a lifting mechanism or container lifting mechanism or crane mechanism to lift a storage container from above. The crane mechanism comprises a winch tether or cable 38 wound on a spool or reel (not shown) and a grabber device 39 in the form of a lifting frame. The lifting device comprise a set of lifting tethers 38 extending in a vertical direction and connected nearby or at the four corners of the lifting frame 39, otherwise known as the grabber device (one tether near each of the four corners of the grabber device) for releasable connection to a storage container 10. The grabber device 39 is configured to releasably grip the top of a storage container 10 to lift it from a stack of containers in a storage system of the type shown in FIGS. 1 and 2.

The wheels 34, 36 are arranged around the periphery of a cavity or recess, known as a container-receiving recess 41, in the lower part. The recess is sized to accommodate the container 10 when it is lifted by the crane mechanism, as shown in FIG. 5, views (a) and (b). When in the recess, the container is lifted clear of the rails beneath, so that the vehicle can move laterally to a different location. On reaching the target location, for example another stack, an access point in the storage system or a conveyor belt, the bin or container can be lowered from the container receiving portion and released from the grabber device. The container receiving space may comprise a cavity or recess arranged within the vehicle body, e.g., as described in WO2015/019055 (Ocado Innovation Limited). Alternatively, the vehicle body of the load handling device may comprise a cantilever as taught in WO2019/238702 (Autostore Technology AS), in which case the container receiving space is located below a cantilever of the load handing device. In this case, the grabber device is hoisted by a cantilever such that the grabber device is able to engage and lift a container from a stack into a container receiving space below the cantilever.

Typically, the load handling device comprises one or more electrical components such as a rechargeable power source to provide power to the drive units for operating the lifting mechanism and the wheel positioning mechanism and a control unit. For example, one or more load handling devices remotely operable on the grid structure are configured to receive instructions from a master controller to retrieve a storage container from a particular a storage location within the grid framework structure. Wireless communications and networks may be used to provide the communication infrastructure from the master controller via one or more base stations to the one or more load handling devices operative on the grid structure. A controller in the load handling device in response to receiving the instructions is configured to control various driving mechanisms to control the movement of the load handling device. For example, the load handling device may be instructed to retrieve a container from a storage column at a particular location on the grid structure. The instruction can include various movements in an X-Y direction on the grid structure. Once at the storage column, the lifting mechanism is then operated to grab the storage container and lift it into a container receiving space in the body of the load handling device where it is subsequently transported to a another location on the grid structure commonly known as a drop off port. The container is lowered to a suitable pick station allow retrieval of the item from the storage container. Movement of the load handling devices on the grid structure also involves the load handling devices being instructed to move to a charging station which is usually located at the periphery of the grid structure. The electrical components of the load handling device are typically housed within the body of the load handling device.

The specific example of a load handling device illustrated in FIGS. 4 and 5 shows the load handling device 30 with a body that is substantially box-shaped with four sidewalls and a top wall, with the components of the load handling device housed within the body. In other examples the body may comprise an open frame or skeleton structure 42, within or upon which components of the load handling device 30 are supported.

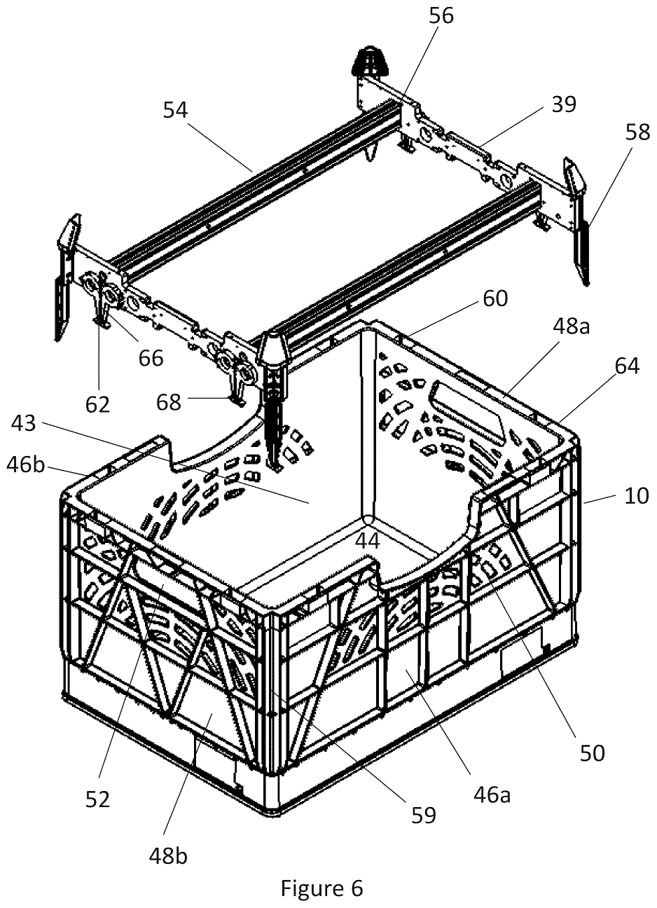

FIG. 6 show a grabber device positioned above one form of bin 10 for use within the storage and retrieval system of FIGS. 1 to 3. The storage container or bin 10 comprises a substantially box type structure having an open top 43, a container bottom wall 44, and opposing sidewalls 46 (a and b) and end walls 48 (a and b). In the particular example shown in FIG. 6, the bin 10 has a substantially rectangular shaped container bottom wall 44 such that the length of the opposing sidewalls 46 (a and b) are longer than the length of the opposing end walls 48 (a and b). The opposing sidewalls 46 (a and b) and end walls 48 (a and b) of the bin comprises one or more ribs to reinforce the sidewalls and end walls of the storage container. A plurality of the bins 10 may be stacked in a self-supporting stack 12, a plurality of stacks 12 being disposed within the grid framework structure 14 as described above. In storage facilities of the type described with reference to FIGS. 1 to 3, it will be appreciated that there may be a large number of bins 10, in some cases hundreds of thousands. Typically, each bin 10 must be able to bear the load of multiple bins 10 in a stack. The bin stack load is carried by the maximum load of twenty fully loaded bins. The weight of a fully loaded bin is about 35 kg, of which 5 kg represents the weight of the bin alone. For example, a stack of twenty bins 10 would represent a load of 700 kg or 6,867 N. The one or more ribs on the opposing sidewalls and end walls strengthens the sidewalls and end walls so as to prevent sidewalls and end walls buckling under such a load in a stack.

To allow air to flow within the bins 10 when held in a stack, the sidewalls 46 (a and b) and/or end walls 48 (a and b) of the bins 10 comprise one or more slots or openings or vent holes 50. The slots or openings 50 in the sidewalls 46 (a and b) and/or end walls 48 (a and b) allow air circulating within and around the storage and retrieval system to flow within the bins 10. This is particularly important in the case where the bins 10 are located in a chilled zone of the storage and retrieval system where cool air from a refrigerated or air conditioning unit is circulated around at least a portion of the grid framework structure for keeping items such as grocery items at a chilled temperature. Cooling systems such as that described in UK Patent Application No GB1509661.3 (Ocado Innovation Limited) and related U.S. Pat. No. 11,667,456, which is incorporated herein by reference in its entirety, require air to flow within the storage system and through the bins 10 and stacks 12 of bins 10; the system described in that UK patent application and US patent includes a storage system comprising one or more heater and/or one or more chiller for generating temperature-controlled gas, one or more fans for circulating the temperature controlled gas through the storage system; and a plenum for receiving the temperature controlled gas. Should a portion of the storage and retrieval system require cooling to a lower temperature, for example to enable storage of items requiring chilling, such as fruit and vegetables, it is more important that the air flow through the system cools the items to be stored. While the embodiments herein are described with reference to cooling the storage system, it will be appreciated that, using the same method described, the items stored in the storage system may be heated in a similar manner. Furthermore, while the description above refers to air flow, it will be appreciated that any suitable gas may be circulated to heat or cool the system as required.

In addition to allowing air to circulate within the bins, the slots 50 in the bins 10 enable the same amount of storage volume to be utilised, while maintaining the structural integrity of the bin 10 yet reducing the weight of the bin 10. Advantageously, providing apertures 50 in the containers DT or bins 10 also reduces the cost of each container DT or bin. In a storage and retrieval system 1 comprising hundreds of thousands of containers and bins this can represent a significant saving. In the drawing of the bin 10 shown in FIG. 6, two sides of the container or bin comprise openings or holes 50. One or more handles 52 are integrally formed into the end walls 48 (a and b) of the bin 10 to enable the storage container to be manually picked up by an operative. The openings or vent holes 50 in the sidewalls 46 (a and b) and/or end walls 48 (a and b) are located at a predetermined height above the bottom wall 44 of the storage container 10 so as to provide a leak proof base, and thereby prevent escape of fluid that has accidently escaped from the contents of the storage container contaminating the contents of adjacent storage containers in a stack.

Also shown in FIG. 6 is the grabber device 39, which forms part of the lifting mechanism 33 of the robotic load handling device, positioned above the bin 10. The lifting mechanism 33 used to lift the containers into the container receiving space can take any suitable form and comprises a winch or a crane mechanism (see FIG. 4). The crane mechanism comprises a winch cable 38 wound on a spool or reel and a grabber device 39. The grabber device 39 is configured to grip the top of the container 10 to lift it from a stack of containers in a storage system of the type shown in FIGS. 1 and 2. Typically, the grabber device 39 is configured as a frame 54 and four lifting tethers 38 are fixed to each corner of the grabber device 39 (see FIG. 5, view (b)). For maximum stability and load capacity, commonly four lifting tethers 38 are used to winch the grabber device 39, with one tether disposed nearby or at each of the corners of the grabber device 39, but a different arrangement, for example with fewer tethers, could be used if desired. One end, e.g., first end, of each of the tethers is wound on the spool in the load handling device and the other end, e.g., second end, is fixed to the grabber device 39, typically at each corner of the grabber device, by a suitable bracket (not shown). The number of tethers attached to the grabber device is dependent on the ability to maintain the grabber device horizontal during operation when picking up a container 10 and the ability to withstand the tension applied to the tethers when lifting containers, which could weigh up to 40 kg, without extending or stretching, i.e., be inextensible under a predetermined applied tensile stress. To possess the necessary physically properties (e.g., Young's Modulus), the tethers are generally in the form of a tape, but other tethers with the necessary physical properties to winch containers are permissible to winch the bin from a stack.

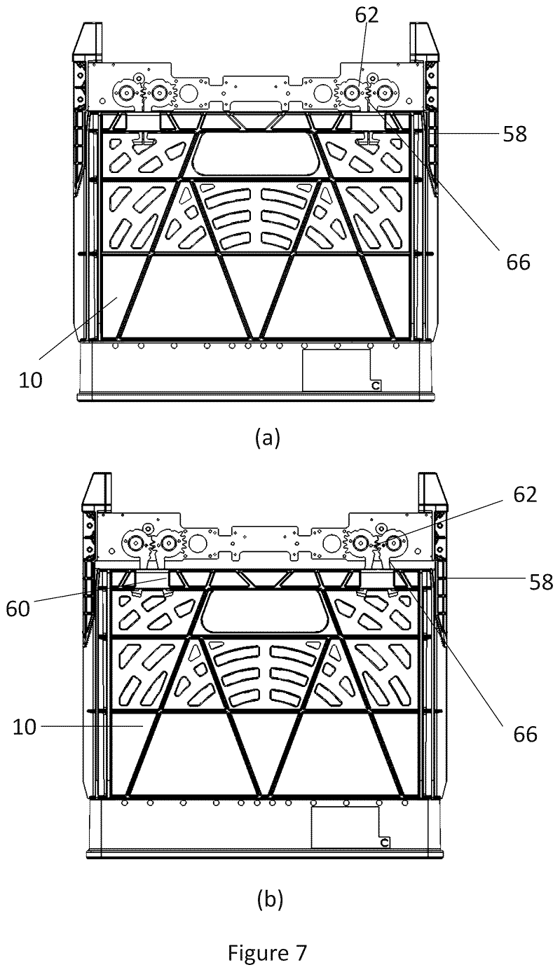

In the particular embodiment shown in FIG. 6, the frame 54 of the grabber device has four corner sections 56, a top side and a bottom side. To grab a container 10, the grabber device 39 comprises four locating pins or guide pins 58 nearby or at each corner of the grabber device 39 which mate with corresponding cut outs or holes 60 formed at four corners of the container 10 and four gripper elements 62 arranged at the bottom side of the grabber device 39 to engage with the rim 64 of the bin 10 (see FIG. 7, view (a)). The locating pins 58 help to properly align the gripper elements 62 with corresponding holes 60 in the rim 64 of the container. In the particular embodiment shown in FIG. 7, view (a), each of the gripper elements 62 comprises a pair of wings 66 that are collapsible to be receivable in corresponding holes 60 in the rim 64 of the container and an open enlarged configuration having a size greater than the holes 62 in the rim 64 of the container 10 in at least one dimension so as to lock onto the container 10 (see FIG. 7, view (b)). The wings are driven into the open configuration by a drive gear (not shown). More specifically, the head of at least one of the wings comprises a plurality of teeth that mesh with the drive gear such that when the gripper elements 62 are actuated, rotation of the drive gear causes the pair of wings to rotate from a collapsed configuration (FIG. 7, view (a)) to an open enlarged configuration (FIG. 7, view (b)).

When in the collapsed or closed configuration, the gripper elements 62 are sized to be receivable in corresponding holes 60 in the rim 64 of the container 10 as shown in FIG. 7, view (a). The foot of each of the pair of wings comprises a stop 68 (see FIG. 6), e.g. a boss, such that when received in a corresponding hole 60 in the rim 64 of the container 10, the stop 68 engages with an underside of the rim 64 when in an enlarged open configuration to lock onto the container when the grabber device 39 is winched upwards towards the container-receiving space of the load handling device. FIG. 7, view (b) shows the configuration of the gripper elements in an enlarged configuration for lifting the bin 10 into the container receiving space of the robotic load handling device.

The gripper elements 64 are received in the holes 60 in the rim 64 of the container 10 when the grabber device 39 is at a predetermined height above the rim of the container as measured by one or more depth sensors (not shown) mounted to the underside of the grabber device. At this depth, the gripper elements 64 are actuated to grab the bin 10 in response from a signal from the one or more of the depth sensors (not shown) mounted to the underside of the grabber device 39.

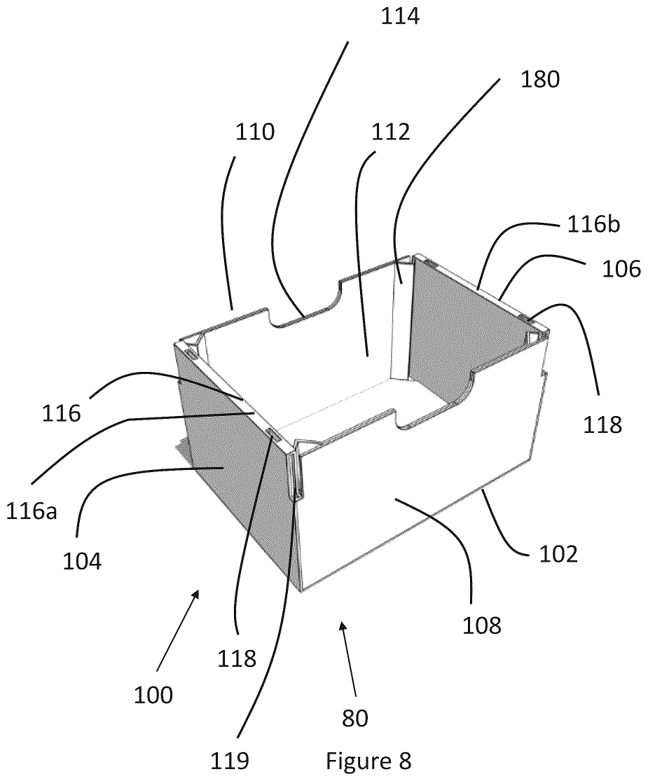

FIG. 8 is a perspective view of a storage container according to an embodiment of the invention. The container 100 is formed from cellulose (for example cardboard) and comprises a bottom wall 102, and four upwardly standing sidewalls: a first upwardly standing sidewall 104 and an opposing second upwardly standing sidewall 106, a front wall 108 and an opposing back wall 110. The front upwardly standing wall 108 and the opposing back upwardly standing wall 110 are understood as being upwardly standing sidewalls. The front wall 108 and the opposing back wall 110 are the longersidewalls of the four sidewalls and the first upwardly standing sidewall 104 and the opposing second upwardly standing sidewall 106 are the shorter sidewalls of the four sidewalls. The front wall 108 and back wall 110 and upwardly standing sidewalls 104, 106 upwardly extend from and are connected to the bottom wall 102 to form a box-like structure with an opening 112 for receiving one or more items within the box-like structure 80. As shown in FIG. 8, the front wall 108 and the back wall 110 each comprise a cut-out 114. By having a cut-out 114 in each of the front wall 108 and the back wall 110, the storage container can be used to hold a delivery container (also termed a delivery tote).

The container 100 of FIG. 8 also comprises a rim portion 116 that extends around the periphery of the opening 112. Specifically, the rim portion 116 extends along the top edge of the first upwardly standing sidewall 104 and the top edge of the second upwardly standing sidewall 106 (i.e. the shorter sides), such that there are two separate sections 116a, 116b of the rim portion 116. Although not shown in FIG. 8, the rim portion 116 may additionally extend along the top edge of the front wall 108 and the back wall 110 (i.e. the longer sides). Thus, the rim portion 116 may extend substantially continuously along the top edges of the four upwardly standing sidewalls. The rim portion 116 provides a surface on which a second container can rest. Thus, a stack of containers can be formed from a plurality of containers where each container rests on the rim portion of the container below. As shown in FIG. 8, the rim portion 116 comprises engagement features in the form of holes 118 for engaging with gripper elements of a grabber device of a load handling device in the same way as described for FIGS. 6 and 7. Specifically, when the wings of the gripper elements are in the collapsed or closed configuration, the wings can be received in the holes 118 in the rim 116 of the container and the stop of each of the pair of wings engages with an underside of the rim 116 when in an enlarged open configuration to lock onto the container when the grabber device is winched upwards towards the container-receiving space of the robotic load handling device.

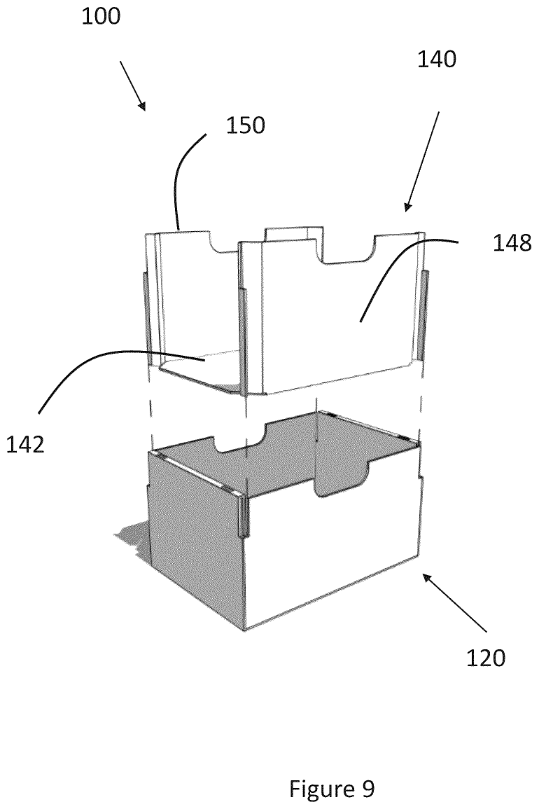

FIG. 9 illustrates that the storage container 100 is formed from two pieces: an exterior piece 120 and an interior piece or liner 140. The liner 140 comprises a first front upwardly standing liner wall 148 and an opposing back upwardly standing liner wall 150 connected by a interior bottom wall 142. In FIG. 9, the first front upwardly standing liner wall 148 and the opposing back upwardly standing liner wall 150 form the longer interior sides of the storage container. The liner 140 is dropped or placed into the exterior piece 120 as shown in FIG. 9.

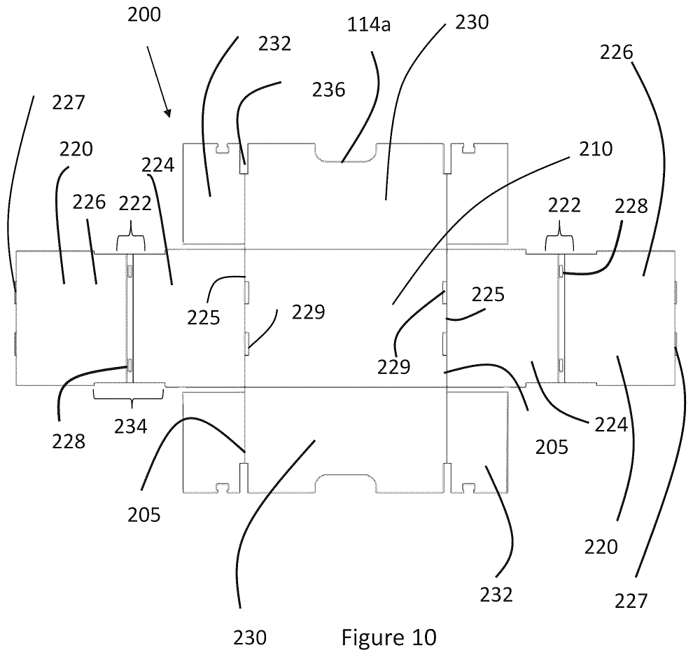

The exterior piece 120 is formed from a blank 200, as shown in FIG. 10. The blank 200 comprises a base portion 210, a first pair of outwardly extending portions 220, and a second pair of outwardly extending portions 230. The first pair of outwardly extending portions 220 extend in a direction perpendicular to the second pair of outwardly extending portions 230. The base portion 210 of the blank 200 forms the bottom wall 102 of the container 100. The first pair of outwardly extending portions 220 form the first upwardly standing sidewall 104 and the second upwardly standing sidewall 106 (i.e. the shorter sides) of the container. The second pair of outwardly extending portions 230 form the front upwardly standing wall 108 and the opposing back upwardly standing wall 110 of the container 100.

The blank 200 comprises a plurality of fold lines 205 to allow the blank to be folded to form the first upwardly standing sidewall 104, second upwardly standing sidewall 106, front upwardly standing wall 108 and back upwardly standing wall 110 of the container. Each portion of the first pair of outwardly extending portions 220 comprises a pair of fold lines 222 for twice folding the outwardly extending portion to form the rim portion 116 of the container 100. The blank comprises holes or apertures 228 between the pair of fold lines 222 that correspond to the holes 118 within the rim portion 116 for engaging with a grabber device. Each of the first pair of outwardly extending portions 220 comprises a first section 224 and a second section 226. The first second and the second section are located on either side of the pair of fold lines 222. The second section 226 is closest to a free end of the outwardly extending portion 220, and the first section 224 is closest to the base portion 210.

To form the first and second upwardly standing sidewalls 104, 106 of the storage container 100, the first sections 224 of each of the outwardly extending portions 220 are folded inwards at a fold line 225 between the first sections 224 and the base portion 210. The first sections 224 are folded towards the base portion 210 so that the first sections 224 extend in a (vertical) direction substantially perpendicular to the direction of the base portion 210. Then each of the outwardly extending portions 220 is folded at the pair of fold lines 222 to form a substantially horizontal platform, i.e., the rim portion 116. Specifically, each outwardly extending portion 220 is folded outwards (i.e., away from the base portion 210) along a first fold line of the pair of fold lines 222, the first fold line being nearest the first section 224. Then each outwardly extending portion 220 is folded at the second fold line of the pair of fold lines 222, the second fold line being furthest from the first section 224, such that the second section 226 extends in a direction parallel to the first section 224. The second sections 226 form exterior surfaces of the first upwardly standing sidewall 104 and the second upwardly standing sidewall 106 of the storage container 100. To retain the second sections 226 in a vertical position parallel with the first sections 224, each portion of the first pair of outwardly extending portions 220 comprises a pair of tabs 227 that extend from the free-ends of the outwardly extending portions 220. The pair of tabs 227 of each outwardly extending portion 220 can engage with a pair of slots 229 located at the fold line 225 between each outwardly extending portion 220 (specifically the first section 224) and the base portion 210.

To form the front wall 108 and the opposing back wall 110 of the storage container 100, each of the second pair of outwardly extending portions 230 is folded inwardly towards the base portion 210 such that the outwardly extending portions 230 extend substantially vertically with respect to the base portion 210. Each portion of the outwardly extending portions 230 comprises two flaps 232 that are each foldable inwards such that the outwardly extending portion forms a U-shape when folded. The flaps 232 are folded and positioned such that each flap is enveloped between the folded first and second sections 226, 228 of each portion of the pair of outwardly extending portions 220. This arrangement links all of the upwardly standing sidewalls together, thereby increasing the rigidity of the storage container 100.

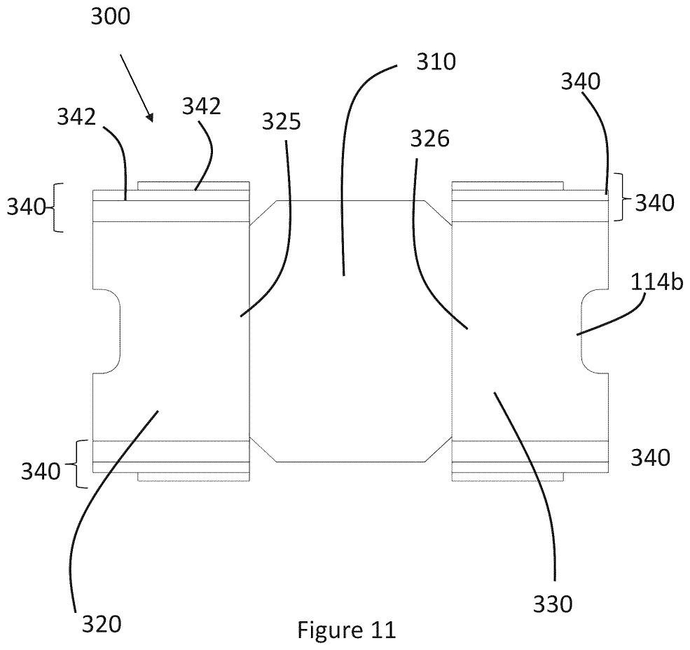

The liner 40 of the storage container 100 is also formed from a blank. The liner blank 300 is shown in FIG. 11 and comprises a liner base portion 310 between a first outwardly extending panel portion 320 and a second outwardly extending panel portion 330. The liner base portion 310 forms the interior bottom wall 142 of the liner and the first outwardly extending panel portion 320 and the second outwardly extending panel portion 330 forms the first front upwardly standing liner wall 148 and the opposing back upwardly standing liner wall 150. Between the liner base portion 310 and the first outwardly extending panel 320 is a first fold line 325, and between the liner base portion 310 and the second outwardly extending panel is a second fold line 326. Folding the blank 300 along the first and second fold lines 325, 326 such that the first and second outwardly extending panel portions 320, 330 are folded inwards towards the liner base portion 310 results in a substantially U-shaped structure comprising upwardly standing liner sidewalls 148, 150.

The first outwardly extending panel portion 320 and the second outwardly extending panel portion 330 of the liner blank 300 each further comprise a flange 340 at each edge of the outwardly extending panel portions 320, 330. Each flange is foldable along two parallel fold lines such that each flange is foldable inwardly upon itself to form a tubular reinforcement post 180 having a triangular cross section, as shown in FIG. 8. Thus, the tubular reinforcement posts are integral with the liner 140. The tubular reinforcement posts 180 are located inside each corner of the storage container 100. The tubular reinforcement posts 180 improve the rigidity and structural integrity of the storage container 100.

While not shown in the figures, the tubular reinforcement posts 180 may be separate from the exterior piece 120 and the liner 140 of the storage container 100. For example, the tubular reinforcement posts 180 may be plastic or metal corner posts or separate cardboard corner posts.

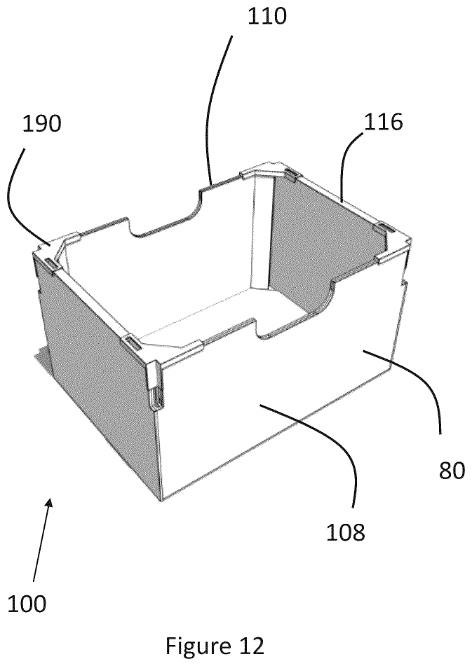

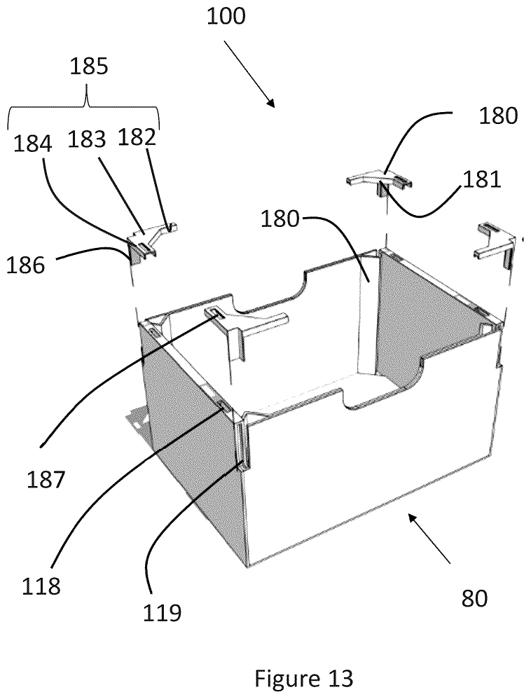

To help hold the tubular reinforcement posts 180 in position inside each corner of the box-like structure 80, and to hold the upper sidewalls of the storage container together, the storage container 100 also comprises a cap 190 engaged at each of the corners of the box-like structure 80, as shown in FIG. 12. Specifically, each cap 190 is engaged with the rim portion 116 and the top edges of the front wall 108 and the opposing back wall 110 of the storage container 100. The caps 190 and their engagement with each corner of the box-like structure 80 is more clearly shown in FIG. 13.

FIG. 13 shows that at the exterior of each corner of the box-like structure 80, there is a vertical notch or slot 119 that extends along a portion of the corner of the box-like structure. Each notch 119 is formed from an indention 234 in the blank 200 of the exterior piece 120 of the storage container 100 specifically located along a portion of each of the lateral edges of the first pair of outwardly extending portions 220, and additionally each notch is formed from a cut-out 236 located at the second pair of outwardly extending portions 230 along the fold lines upon which the two flaps 232 are folded inwards.

FIG. 13 also shows that each cap 180 comprises a first portion 182, a second portion 184 and the third portion 186. The first portion 182 extends in a direction substantially perpendicular to the second portion 184. The first portion 182 and the second portion 184 engage with the rim portion 116 and the top edges of the front wall 108 and the opposing back wall 110 of the box-like structure 80. The underside of each of the first and second portions 182, 184 comprises a channel or groove into which the rim portion 116 and the top edges of the front wall 108 and the opposing back wall 110 can engage. The first and second portions 182, 184 define a corner piece 185. As shown in FIG. 13, the first or second portion 182, 184 comprises an aperture 187 that is arranged to align with the apertures or holes 118 in the rim portion 116. The aperture 187 of the corner piece 185 is configured to extend into a portion of the hole 118 of the rim portion to reinforce the periphery of the hole 118. The corner piece 185 also comprises a retainer 183 at the interior angle between the first and second portions 182, 184. The retainer 183 is configured such that it retains the tubular reinforcement posts 180 at the interior of each corner. Specifically, the underside of the retainer 183 comprises a ridge 181 that retains the tubular reinforcement post 180 within the corner of the box-like structure.

The third portion 186 of the cap 180 downwardly extends in a third direction that is perpendicular to the first direction and the second direction to define a grabber device guide. The third portion 186 is designed to fit within the notch 119 at the corner of the box-like structure 80 and extend along the corner of the box-like structure. The third portion 186 is indented to allow a guide pin 58 (shown in FIG. 6) of a lifting device of a load handling device to mate with the third portion. As shown in FIG. 13, each cap 180 is located at each corner of the box-like structure 80 and therefore a third portion 186 is located at each corner so the guide pins 58 can locate each corner and allow the gripper elements of the grabber device 39 to properly align with the corresponding holes 118 in the rim 116 of the container 100.

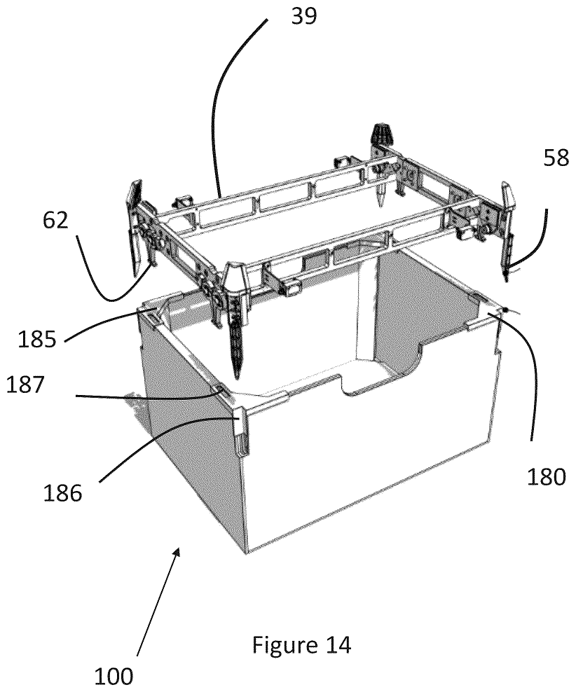

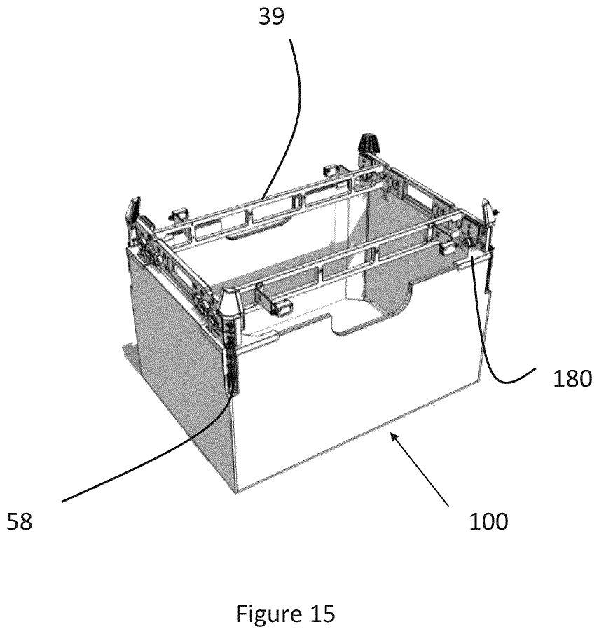

FIGS. 14 and 15 show the engagement of the grabber device with the storage container. The grabber device is the same grabber device as shown in FIGS. 6 and 7. FIG. 14 shows the grabber device 39 positioned directly above the storage container 100. Each locating pin 58 of the grabber device 39 is aligned with each corner of the storage container 100. Specifically, each locating pin 58 is aligned with each grabber device guide defined by the third portion 186 of the cap 180. When the grabber device 39 is lowered to engage with the storage container, each locating pin 58 mates with each grabber device guide defined by the third portion 186 of the cap 180, thereby aligning the gripper elements 62 with corresponding holes 118 in the rim portion 116 of the storage container 100 and apertures 187 in the corner piece 185 of the cap 180. The pair of wings 66 of each of the gripper elements 62 are received in the corresponding holes 118 and apertures 187 in the collapsed configuration. Once the pair of wings 66 of each of the gripper elements 62 is received in the corresponding holes 118 and apertures 187, the pair of wings 66 are positioned between the folded first section 224 and a second section 226 of the blank 200 of the exterior piece 120 and are therefore not visible from the exterior of the storage container 100. The pair of wings 66 then moves into an open enlarged configuration having a size greater than the holes 118 and apertures 187 in at least one dimension so as to lock onto the container 100. Specifically, each pair of wings 66 locks onto the underside of the rim portion 116 of the container.

As shown in FIGS. 8, 9 and 12 to 15, the storage container 100 comprises a cut-out 114 in the front upwardly standing wall 108 and the opposing back upwardly standing wall 110. Consequently both the blank 200 forming the exterior piece 120 of the container comprises a cut-out 114a along the edge of the second pair of outwardly extending portions 230, and the liner blank 300 comprises a cut-out 114b along the edge of the first outwardly extending panel portion 320 and along the edge of the second outwardly extending panel portion 330. Thus, the storage container 100 can be used to hold a delivery container. Alternatively, if a storage container 100 is not required to hold a delivery container, the cut-outs 114a, 114b in the blank 200 and liner blank 300 can be omitted.

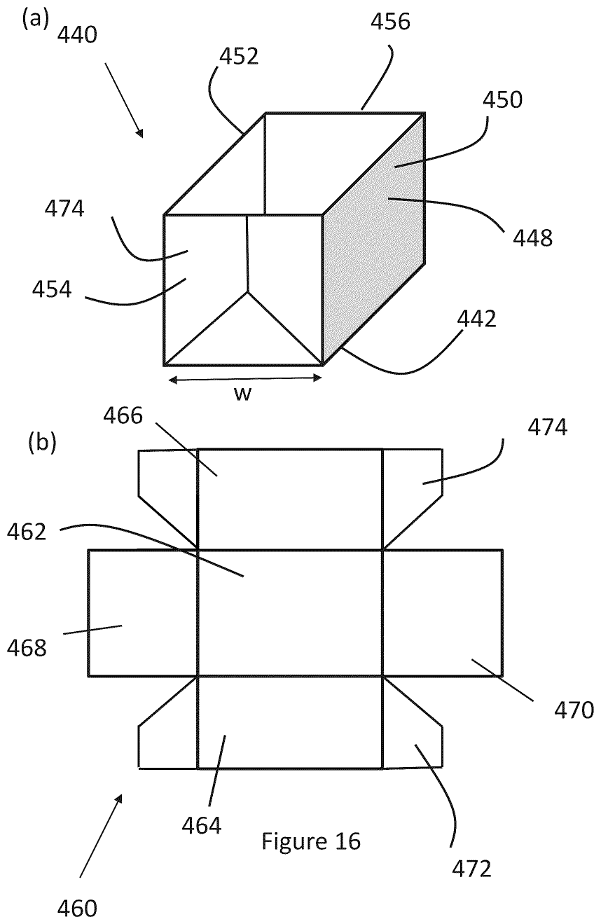

FIG. 16 includes views (a)-(b), and illustrates an alternative liner that may be used. In contrast to the liner 140 shown in FIG. 9 which has two upwardly standing sidewalls 148, 150, the liner 440 in FIG. 16, view (a), comprises a base wall 442 and four upwardly standing liner sidewalls 448 (a front wall 450 and an opposing back wall 452 (i.e., longer side walls) and a first upwardly standing sidewall 454 and an opposing second upwardly standing sidewall 456 (i.e., shorter sidewalls)) to form a box-like liner structure. The liner 440 is formed from a blank 460 as shown in FIG. 16, view (b). The blank 460 comprises a liner base portion 462, a first outwardly extending panel portion 464, a second outwardly extending panel portion 466, a third outwardly extending panel portion 468, a fourth outwardly extending panel portion 470. The first outwardly extending panel portion 464 and the second outwardly extending panel portion 466 form the front wall 450 and the opposing back wall 452 respectively. The third outwardly extending panel portion 468 and the fourth outwardly extending panel portion 470 form the first upwardly standing sidewall 454 and the opposing second upwardly standing sidewall 456 (i.e., the shorter sidewalls) respectively. The first outwardly extending panel portion 464 comprises a first pair of wings 472 and the second outwardly extending panel portion 466 comprises a second pair of wings 474. Each wing of the pair of wings shown in FIG. 16, view (b), is trapezoidal in shape, however it is also possible that each wing of the pair of wings is substantially triangular in shape.

The liner 460 is folded such that the third outwardly extending panel portion 468 and the fourth outwardly extending panel portion 470 are folded inwards first to form the first upwardly standing sidewall 454 and the opposing second upwardly standing sidewall 456 (i.e., the shorter sides). Then the first outwardly extending panel portion 464 and the second outwardly extending panel portion 466 are folded inwards to form the front wall 450 and the opposing back wall 452 respectively. Finally, each wing 473 is folded over the exterior of the first upwardly standing sidewall 454 and the opposing second upwardly standing sidewall 456, such that each wing overlaps each corner of box-like structure. As shown on FIG. 16, view (a), each folded wing 474 extends across approximately half the width w of the first upwardly standing sidewall 454 or the opposing second upwardly standing sidewall 456, such that each wing contacts its associated wing in its pair of wings along an edge at a position substantially centrally along the width of the first upwardly standing sidewall 454 or the opposing second upwardly standing sidewall 456.

Each wing 474 may not necessarily have the size and shape shown in FIG. 16, views (a) and (b). For example, each wing may extend across approximately a quarter or approximately a third of the width of the first upwardly standing sidewall 454 or the opposing second upwardly standing sidewall 456, thereby meaning that each wing does not contact its associated wing in its pair of wings.

Each wing 474 may be folded in a different way to that shown in FIG. 16, view (a). For example, each wing 473 may be folded such that it partially covers the interior of the first upwardly standing sidewall 454 and the opposing second upwardly standing sidewall 456. Alternatively, each wing may form part of the third outwardly extending panel portion 468 and the fourth outwardly extending panel portion 470 and may be folded over the exterior or interior of the front wall 450 and the opposing back wall 452. All the folded configurations of the outwardly extending panel portions and wings described result in each corner of the box-like liner structure comprising two overlapping layers. The overlapping layers reinforce the corners of the liner and help to retain fluids within the liner.

The blank 460 may be formed from metal, plastic or cardboard. In particular, the blank may be formed from cardboard coated in polypropylene. Polypropylene coated cardboard, metal and plastic are waterproof and can hold liquids or juices which may leak from the products within the storage container. Thus a liner of the type shown in FIG. 16, view (a), being formed from these materials provides a leak proof interior. If the blank is formed from polypropylene coated cardboard the liner may be recycled, and if the blank is formed from metal or plastic the liner may be washed and re-used, thus being more environmentally friendly.

While all the blanks 200, 300, 460 described and illustrated are sheet blanks, i.e., only formed from one sheet, it is also possible that the blanks are formed from more than one sheet. For example, the blank of FIG. 16, view (b), may comprise a first portion comprising the base portion and the first outwardly extending panel portion 464 and the second outwardly extending panel portion 466 (i.e., the longer sides), and a second portion comprising a base portion and the third outwardly extending panel portion 468 and the fourth outwardly extending panel portion 470 (i.e., the shorter sides), such that the base portion of the second portion rests on and preferably is attached to the top of the base portion of the first portion or vice versa. Alternatively, for example, the blank of FIG. 16, view (b), may comprise a first portion comprising the base portion and the first outwardly extending panel portion 464, the second outwardly extending panel portion 466 and the third outwardly extending panel portion 468, and the base portion may comprise a tab onto which the fourth outwardly extending panel portion 470 can be attached by any conventional fixing means, for example glue.

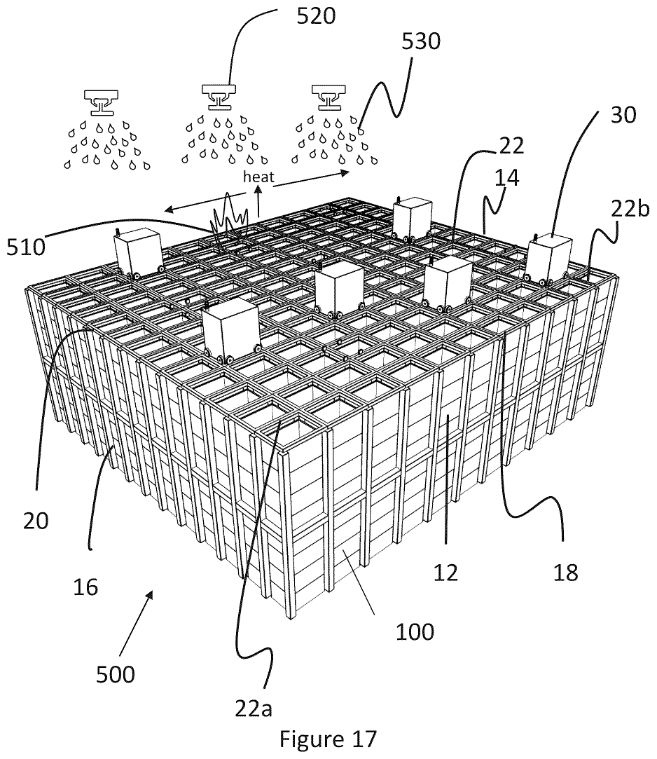

FIG. 17 illustrates the storage and retrieval system 500 of the present invention. The storage containers 100 are stacked in the same way as in FIGS. 1 and 3. In contrast to the systems in FIGS. 1 and 3, the storage containers are formed from a cellulose material. Cellulose fibres are highly combustible and therefore have a lower activation energy for oxygenation to occur at ambient oxygenation temperature. If a storage container in the grid framework structure reaches an ignition temperature, it will oxidise in air, set alight and give off heat. The heat is transferred to the surroundings by convection, conduction or radiation causing the surroundings to oxidise. Because heat more easily moves upwards during to convection, the heat and therefore the fire can travel up a stack of storage containers quickly. In addition, as the containers are arranged in stacks, the fire can transfer from direct contact of a heated storage container to an adjacent storage container in a stack. In particular, corrugated cardboard allows air to flow along the fluting of the corrugated inner medium. If the fluting is arranged in a vertical direction, this can aid the flow of heated air up the stack of containers. As the hot air rises, it spreads laterally along the ceiling of the building housing the system, and activates fire sprinklers positioned above the grid framework structure. The water 530 from the fire sprinklers can travel down the fluting in the corrugated cardboard and/or down the cellulose fibres to put out the fire.

As described previously, the storage containers 100 are arranged in stacks 12 and each stack is separated from an adjacent stack by a gap 15, as shown in FIG. 2. Since air has a lower thermal conductivity than that of solids because its molecules are not in continuous contact with one another like in a solid, it becomes more difficult for heat to be transferred laterally from stack to stack in the grid framework structure. Thus, a fire is more likely to move up a stack of storage containers and spread laterally across containers at the top of the stacks where the air is hotter. In this way, a fire 410 is likely to remain localised to a stack of containers as the fire moves up the stack 12, as shown in FIG. 17, until it reaches the container at the top of the stack where the air is warmer. The temperature of the air above the fire will therefore be sufficient to activate the fire sprinklers 520 and extinguish the fire 510.

In addition, if the storage containers store ambient goods, the storage and retrieval system does not require a fan or any other such device that causes forced air movement within the grid framework structure. Thus, heated air is not activately encouraged to move laterally, and the movement of air in the grid framework structure is by conventional convection.

It will be appreciated that a storage container can be designed for a particular application using various combinations of the arrangements described above. It will be appreciated that the features described herein may all be used together in a single system. In other embodiments of the invention, some of the features may be omitted. The features may be used in any compatible arrangement. Many variations and modifications not explicitly described above are possible without departing from the scope of the invention as defined in the appended claims.

Further features of the invention may be described with reference to the following numbered clauses:

Clause 1. A storage container for the storage of one or more items in a storage and retrieval system, the storage and retrieval system comprising:
(i) a track system comprising a first set of parallel rails or tracks and a second set of parallel rails or tracks running transversely to the first set of parallel tracks in a substantially horizontal plane to form a grid pattern for guiding one or more robotic load handling devices on the track system, the grid pattern comprising a plurality of grid spaces or grid cells;
(ii) a plurality of stacks of storage containers located beneath the track system and wherein each stack of the plurality of stacks of storage containers occupies a single grid space or grid cell; and
(iii) a plurality of load handling devices for lifting and moving storage containers stacked in the storage columns, each load handling device of the plurality of load handling devices comprising a lifting device arranged to lift a single storage container from a stack into a container-receiving space, wherein the lifting device comprises a grabber device being configured to engage with the storage container;
wherein the storage container comprises a bottom wall, upwardly standing sidewalls and an opening for receiving one or more items to define a box-like structure, each storage container further comprising a rim portion extending around at least a portion of the periphery of the opening of the box-like structure for supporting the bottom wall of an adjacent storage container above in a stack, and wherein a portion of the box-like structure of the at least one storage container in the one or more of the plurality of stacks of storage containers is formed from a cellulose material.

Clause 2. A storage container according to clause 1, wherein the portion of the box-like structure of the at least one storage container in the one or more of the plurality of stacks of storage containers comprises the one or more upwardly standing sidewalls and/or bottom wall.

Clause 3. A storage container according to any preceding clause, wherein the cellulose material is cardboard.

Clause 4. A storage container according to any preceding clause, wherein the box-like structure of the at least one storage container is formed from a folded cardboard blank.

Clause 5. A storage container according to clause 4, wherein the folded cardboard blank comprises a base portion and outwardly extending panel portions, the outwardly extending panel portions being folded along respective fold lines relative to the base portion forming the upwardly standing sidewalls.

Clause 6. A storage container according to any preceding clause, wherein the rim portion comprises one or more engagement features for engaging with the grabber device.

Clause 7. A storage container according to clause 7, wherein the engagement features of the rim portion comprises a plurality of apertures for receiving the grabber device.

Clause 8. A storage container according to clause 7, wherein each storage container further comprises a cap engaged at each of the corners of the box-like structure, each cap comprising a first portion and a second portion, the first portion extending in a first direction and the second portion extending in a second direction, the first portion being substantially perpendicular to the second portion to define a corner piece, the corner piece being configured to be mounted at a corner of the storage container such that the first and second portions hold adjacent upwardly standing sidewalls together at each corner of the box-like structure.

Clause 9. A storage container according to clause 8, wherein the first portion and/or the second portion comprise one or more cap apertures that is configured to align with the one or more apertures in the rim portion when the corner piece is mounted to the corner of the storage container such that each of the one or more cap apertures reinforces the periphery of each of the apertures in the rim portion.

Clause 10. A storage container according to clause 8 or 9, wherein the cap further comprises a third portion downwardly extending in a third direction, the third direction being perpendicular to the first direction and the second direction to define a grabber device guide, each guide being configured to extend along each corner of the storage container to align the gripper elements of the grabber device with the aperture of the rim portion so as to allow the grabber device to engage with the rim portion of the storage container.

Clause 11. A storage container according to any one of clauses 8 to 10, wherein each cap is formed from plastic.

Clause 12. A storage container according to any preceding clause, wherein each storage container further comprises a tubular reinforcement post at each corner of the storage container.

Clause 13. A storage container according to any preceding clause, wherein the storage container comprises a liner being formed from a second blank.

Clause 14. A storage container according to clause 13, wherein the second blank comprises a base portion and a pair of outwardly extending panel portions, the outwardly extending panel portions being folded along respective fold lines relative to the base portion forming a substantially U-shaped structure comprising upwardly standing liner sidewalls.

Clause 15. A storage container according to clause 14, wherein the second blank further comprises a flange formed at each edge of the upwardly standing liner sidewalls, the flange being foldable inwardly upon itself along two parallel fold lines to form the tubular reinforcement post.

Clause 16. A storage container according to clause 13, wherein the second blank comprises a base portion and two pairs of outwardly extending panel portions, the outwardly extending panel portions being folded along respective fold lines relative to the base portion forming a box-like liner structure comprising upwardly standing liner sidewalls.

Clause 17. A storage container according to clause 16, wherein the second blank further comprises a wing formed at each edge of a single pair of the upwardly standing liner sidewalls, each wing being foldable to overlap each corner of the box-like liner structure.

Clause 18. A storage container according to any one of clauses 13 to 17, wherein the second blank comprises cardboard.

Clause 19. A storage container according to clause 18, wherein the cardboard is coated in polypropylene.

Clause 20. A storage container according to any one of clauses 13 to 17, wherein the second blank is formed from plastic.

What is claimed is:

1. A storage and retrieval system comprising:
(a) a grid framework structure comprising a plurality of storage columns for the storage of a plurality of stacks of storage containers, a track system comprising a plurality of tracks arranged in a grid pattern comprising a plurality of grid cells arranged above the plurality of storage columns for guiding one or more robotic load handling devices on the grid framework structure, the plurality of tracks being arranged such that each of the plurality of storage columns is below a single grid cell;
(b) a plurality of stacks of storage containers, each stack of the plurality of storage containers occupying a single storage column of the plurality of storage columns, wherein each storage container of the plurality of stacks of storage containers comprises a bottom wall, upwardly standing sidewalls and an opening for receiving one or more items to define a box-like structure, each storage container further comprising a rim portion extending around at least a portion of the periphery of the opening of the box-like structure for supporting the bottom wall of an adjacent storage container above in a stack, and wherein a portion of the box-like structure of the at least one storage container in the one or more of the plurality of stacks of storage containers is formed from a cellulose material; and
(c) a plurality of robotic load handling devices for lifting and moving storage containers stacked in the storage columns, the plurality of load handling devices being remotely operated to move laterally on the track system above the plurality of storage columns to access the storage containers through the grid cells, each of said plurality of robotic load handling devices comprising:
(i) a wheel assembly for guiding the load handling device on the track system;
(ii) a container-receiving space located above the track system; and
(iii) a lifting device arranged to lift a single storage container from a stack into the container-receiving space, wherein the lifting device comprises a grabber device being configured to engage with the storage container, wherein the grabber device comprises gripper elements for engaging with the rim portion of the storage container.

2. A system according to claim 1, wherein the portion of the box-like structure of the at least one storage container in the one or more of the plurality of stacks of storage containers comprises the one or more upwardly standing sidewalls and/or bottom wall.

3. A system according to claim 1, wherein the cellulose material is cardboard.

4. A system according to claim 1, wherein the box-like structure of the at least one storage container is formed from a folded cardboard blank.

5. A system according to claim 4, wherein the folded cardboard blank comprises a base portion and outwardly extending panel portions, the outwardly extending panel portions being folded along respective fold lines relative to the base portion forming the upwardly standing sidewalls.

6. A system according to claim 1, wherein the rim portion comprises one or more engagement features for engaging with the gripper elements of the grabber device.

7. A system according to claim 6, wherein the engagement features of the rim portion comprises a plurality of apertures for receiving gripper elements of the grabber device.

8. A system according to claim 7, wherein each storage container further comprises a cap engaged at each of the corners of the box-like structure, each cap comprising a first portion and a second portion, the first portion extending in a first direction and the second portion extending in a second direction, the first portion being substantially perpendicular to the second portion to define a corner piece, the corner piece being configured to be mounted at a corner of the storage container such that the first and second portions hold adjacent upwardly standing sidewalls together at each corner of the box-like structure.

9. A system according to claim 8, wherein the first portion and/or the second portion comprise one or more cap apertures that is configured to align with the one or more apertures in the rim portion when the corner piece is mounted to the corner of the storage container such that each of the one or more cap apertures reinforces the periphery of each of the apertures in the rim portion.

10. A system according to claim 8, wherein the cap further comprises a third portion downwardly extending in a third direction, the third direction being perpendicular to the first direction and the second direction to define a grabber device guide, each guide being configured to extend along each corner of the storage container to align the gripper elements of the grabber device with the aperture of the rim portion so as to allow the grabber device to engage with the rim portion of the storage container.

11. A system according to claim 8, wherein each cap is formed from plastic.

12. A system according to claim 1, wherein each storage container further comprises a tubular reinforcement post at each corner of the storage container.

13. A system according to claim 1, wherein the storage container comprises a liner being formed from a second blank.

14. A system according to claim 13, wherein the second blank comprises a base portion and a pair of outwardly extending panel portions, the outwardly extending panel portions being folded along respective fold lines relative to the base portion forming a substantially U-shaped structure comprising upwardly standing liner sidewalls.

15. A system according to claim 14, wherein the second blank further comprises a flange formed at each edge of the upwardly standing liner sidewalls, the flange being foldable inwardly upon itself along two parallel fold lines to form the tubular reinforcement post.

16. A system according to claim 13, wherein the second blank comprises cardboard and/or plastic.
